(19) United States
(12) Patent Application Publication
(10) Pub. No.: US 2014/0050122 A1
(43) Pub. Date: Feb. 20, 2014

(54) SYSTEM AND METHOD FOR CONNECTING COMMUTERS TRAVELING ON A MASS TRANSIT SYSTEM

(71) Applicants: Samuel Pro, Chicago, IL (US); David Eduardo Rogers, Chicago, IL (US)

(72) Inventors: Samuel Pro, Chicago, IL (US); David Eduardo Rogers, Chicago, IL (US)

(73) Assignee: TRANSITCHATTER GROUP, LLC, Chicago, IL (US)

(21) Appl. No.: 13/587,366

(22) Filed: Aug. 16, 2012

(51) Int. Cl. G06Q 30/02; H04W 4/16; G01C 21/00

(52) U.S. Cl. 370/260; 705/14.63; 705/14.61; 701/409

(57) ABSTRACT

A computer-implemented system and method of presenting advertisements to a commuter traveling on a transit line of a mass transit system are provided. Advertisements are automatically associated with transit stops of the transit line. The current geographic location of the commuter is monitored while the commuter is traveling. The commuter is automatically associated with a current transit stop based on the current geographical location of the commuter. Whether the current transit stop is associated with one or more of the advertisements is determined. In response to a determination that the current transit stop is associated with an advertisement, one of the advertisements is automatically selected for presentation at a mobile device operated by the commuter. At least a portion of the selected advertisement is presented to the commuter at the mobile device.

### TECHNICAL FIELD

The field of the invention relates to delivering and presenting advertisements to individuals and, in particular, relates to systems and methods for delivering and presenting geotargeted advertisements to individuals.

### BACKGROUND

Advertisers continue to seek new and effective ways to drive potential customers to their businesses. With the proliferation of mobile computing devices such as cellular telephones and table computers, advertisers may target potential customers by delivering advertisements to those devices. Moreover, mobile devices may be equipped to determine the current geographic location of individuals using, for example, a GPS (Global Positioning System). As a result, advertisers may target individuals based on their respective geographic locations by delivering advertisements for businesses near those locations.

Delivering advertisements to individuals based on their current geographic locations may be referred to as geotargeted advertising. Conventional geotargeted advertising approaches, however, may be designed for the stationary individual. Conventional geotargeted advertising approaches may not be effective where individuals are traveling between locations.

Therefore, a new approach for delivering relevant advertisements to individuals in transit is needed.

### SUMMARY

A system for presenting advertisements to a commuter traveling on a transit line of a mass transit system is provided. The transit line includes multiple transit stops, and the mass transit system is associated with transit description data. A data store is configured to store advertising-related data corresponding to the advertisements. The advertising-related data associates the advertisements with transit stops of the transit lines of the mass transit system. A predictive locator module predicts future geographic locations of the commuter based on a current geographic location of the commuter, the transit line on which the commuter is traveling, and a direction in which the commuter is traveling. A predictive geotargeted advertising module identifies and selects one of the advertisements for presentation to the commuter at a mobile device based on the future geographic locations of the commuter. A mobile communication gateway is configured to transmit to the mobile device the advertising-related data corresponding to the advertisement such that at least a portion of the advertisement is presentable at the mobile device.

A computer-implemented method of predicting future locations of a commuter traveling on a transit line of a mass transit system is additionally provided. The transit line includes multiple transit stops, and the mass transit system is associated with transit description data. The transit line the commuter is traveling on and the direction the commuter is traveling is determined. A current geographic location of the commuter is automatically determined based on geographic information received from a mobile device operated by the commuter. A set of upcoming transit stops of the transit line on which the commuter is traveling is automatically identified based on the current geographic location of the commuter, the direction in which the commuter is traveling, and the transit description data. The commuter is automatically associated with one or more of the upcoming stops.

A system for connecting commuters traveling on transit lines of mass transit systems is further provided. A session management module is configured to establish connections with mobile devices respectively operated by the commuters. The session management module is also configured to associate commuters with the respective transit lines on which the commuters are traveling. A mobile communication gateway is configured to receive communications from the mobile devices operated by the commuters. The mobile communication gateway is also configured to transmit at least a portion of the communications received to the mobile devices operated by the commuters such that the commuters may interact while traveling on the mass transit systems.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout different views.

FIG. 1 is an example of an implementation of a mass transit commuter connection system.

FIG. 2 is another example of an implementation of a mass transit commuter connection system.

FIG. 3A is an example of an implementation of an interface for indicating a mass transit type of a mass transit system.

FIG. 3B is an example of an implementation of an interface for indicating a transit line of a mass transit system.

FIG. 3C is an example of an implementation of an interface for indicating a direction of travel on a transit line of a mass transit system.

FIG. 3D is an example of an implementation of an interface for a chat room connecting commuters traveling on a common transit line.

FIG. 3E is an example of an implementation of an interface for prompting a commuter to confirm or deny estimated travel information.

FIG. 3F is an example of an implementation of an interface for prompting a commuter to select a correct estimated travel information result.

FIG. 4 is a flowchart of example method steps for connecting commuters traveling on a common transit line of a mass transit system

FIG. 5 is a flowchart of example method steps for determining the next upcoming stop to a commuter.

FIG. 6 is a diagram of a portion of an example rail transit line of a rail line transit system.

FIG. 7 is a diagram of a portion of two respective bus line transit lines of a bus transit system.

FIG. 8 is a flowchart of example method steps for presenting predictive geotargeted advertisements to a commuter traveling on a transit line of a mass transit system.

FIG. 9A is an example of an implementation of an interface for presenting a predictive geotargeted advertisement.

FIG. 9B is an example of an implementation of an interface for displaying additional advertisement details.

FIG. 10A is an example of an implementation of an interface for creating a predictive geotargeted advertisement.

FIG. 10B is an example of an implementation of an interface for configuring a predictive geotargeted advertisement.

FIG. 10C is another example of an implementation of an interface for configuring a predictive geotargeted advertisement.

FIG. 10D is an additional example of an implementation of an interface for configuring a predictive geotargeted advertisement.

FIG. 10E is a further example of an implementation of an interface for configuring a predictive geotargeted advertisement.

FIG. 11 is a diagram of an example of an advertising revenue model based around predictive geotargeted advertisements.

### DESCRIPTION

A mass transit commuter connection system and method are provided. As discussed in more detail below, the mass transit commuter connection system facilitates a variety of activities commuters may participate in with other commuters while traveling on the mass transit system (e.g., chatting, gaming, etc.). In addition, the mass transit commuter connection system may facilitate predictive geotargeted advertising for commuters traveling on a transit line of a mass transit system.

### Mass Transit Commuter Connection System

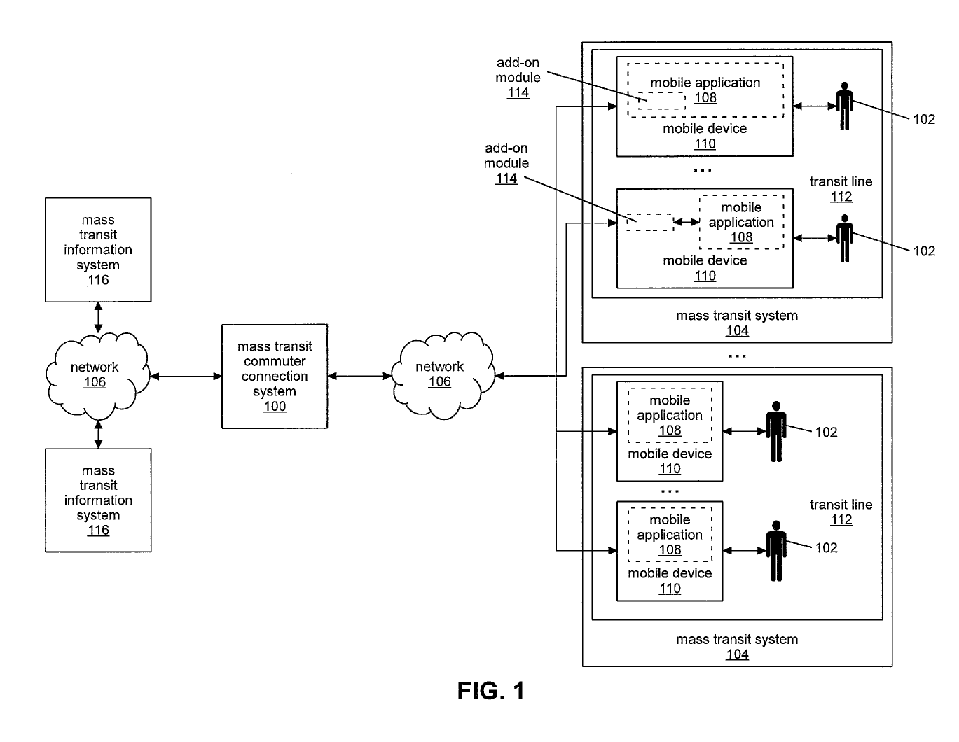

Referring to FIG. 1, an example of an implementation of a mass transit commuter connection system 100 is shown. The mass transit commuter connection system 100 connects commuters 102 traveling on a mass transit system 104. The mass transit commuter connection system 100 connects commuters 102 via a network 106 and a mobile application 108 running at a mobile device 110 operated by the commuter.

A mass transit system 104 may be any type of shared public transportation service for transporting multiple passengers (i.e., commuters 102). Accordingly, types of mass transit systems 104 include: busses and coaches; trolleys and trams; trains such as commuter rail, intercity rail, light rail, and high-speed rail; cable-propelled transit such as cable cars; ferries; airlines; and the like. A mass transit system 104 may include multiple transit lines 112, e.g., multiple bus routes, multiple rail lines, etc.

As an example, the city of Chicago, Ill. has at least two types of mass transit systems 104, a bus transit system and a rail transit system, which are operated by the Chicago Transit Authority (CTA). The CTA bus transit system includes multiple bus routes (e.g., the “#22 bus,” the “#151 bus,” etc.). Likewise, the CTA rail transit system includes multiple rail lines (e.g., the “Red Line,” the “Brown Line,” etc.). Similar entities may operate the mass transit systems 104 in other cities, e.g., the New York City Transit Authority (NYCTA) in New York City, New York and the Massachusetts Bay Transportation Authority (MBTA) in Boston, Mass.

As seen in FIG. 1, the mass transit commuter connection system 100 may connect commuters 102 traveling on the same transit line 112 of a particular mass transit system 104. For example, the mass transit commuter connection system 100 may connect commuters 102 that are each traveling on the CTA Red Line. As another example, the mass transit commuter connection system 100 may connect commuters 102 that are each traveling on the CTA #151 bus. In some example implementations, the mass transit commuter connection system 100 may connect commuters 102 that are traveling on different transit lines 112, e.g., the CTA Red Line and the CTA Blue Line or the CTA #22 bus and the CTA #151 bus.

In FIG. 1, two mass transit systems 104 are shown. These mass transit systems 104 may be different types of mass transit systems in the same city (e.g., the CTA bus system and the CTA rail system) or, additionally or alternatively, these mass transit systems may be mass transit systems in different cities (e.g., the CTA rail system and the NYCTA bus system).

Commuters 102 traveling on a transit line 112 of a mass transit system 104 may interact with a mobile application 108 running at a mobile device 110. The mobile application 108 may be, for example, a stand-alone software application residing at the mobile device 110 and configured to run at the mobile device. The mobile application 108 may additionally or alternatively be a web-based application accessed by a web browser residing at the mobile device 110. As seen in FIG. 1, the mobile application 108 may also include one or more add-on modules 114, which may be a part of the mobile application or a separate, stand alone module in signal communication with the mobile application. Add-on modules 114 will be discussed in further detail below.

The mobile device 110 may be any network-enabled computing device such as, for example, a laptop computer, tablet computer, palmtop computer, mobile telephone; and the like. The mobile device 110 may be in signal communication with the mass transit commuter connection system 100 via a telecommunication network 106. The telecommunication network 106 may be a wired network, a wireless network, or a combination of wired and wireless networks such as, for example, a cellular network and a packet-switched network (e.g., the Internet).

As seen in FIG. 1, the mass transit commuter connection system 100 may also be in signal communication with one or more mass transit information systems 116 via a telecommunication network 106. As discussed further below, a mass transit information system 116 may provide the mass transit commuter connection system 100 with transit system-related information, e.g., transit system description data, real-time transit information, etc. The mass transit information system 116 may be provided by the entity that operates the mass transit system 104, e.g., the CTA, NYCTA, MBTA, etc.

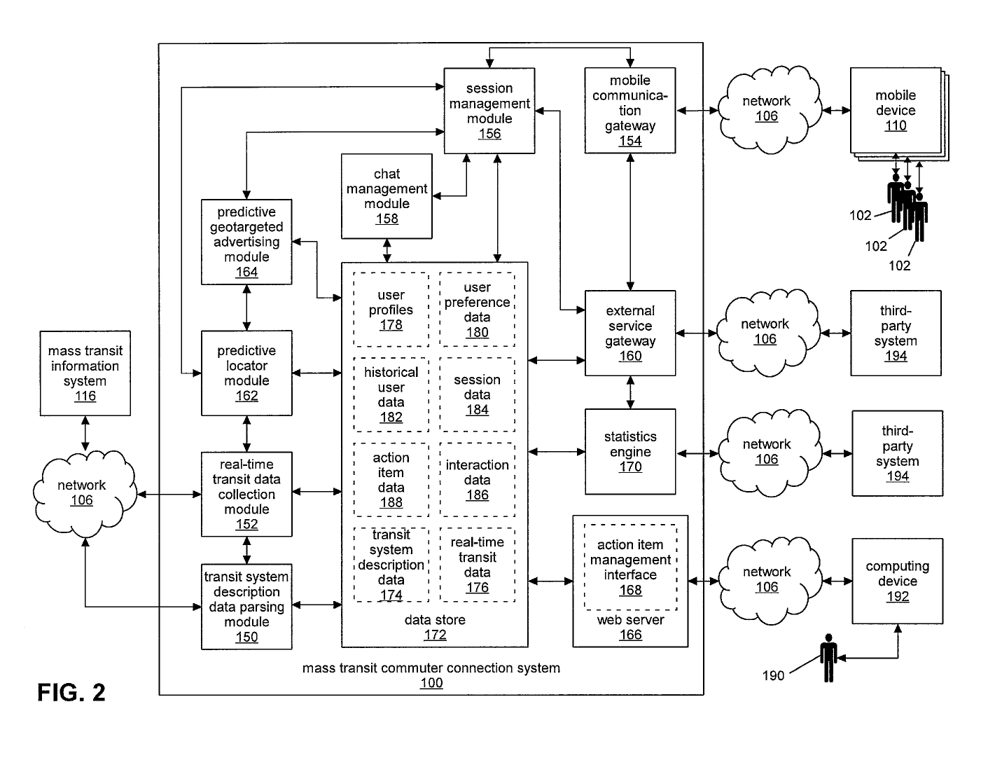

Referring now to FIG. 2, an example of an implementation of a mass transit commuter connection system 100 is shown. The mass transit commuter connection system 100 may be implemented as one or more interconnected computing devices in signal communication with each other. The mass transit commuter connection system 100 may also include various modules to facilitate transit-related, commuter-related, and advertisement-related communications.

In this example, the mass transit commuter connection system 100 includes modules for obtaining and parsing transit system-related information: a transit description data parsing module 150; and a real-time transit data collection module 152. The mass transit commuter connection system 100, in this example, also includes modules for facilitating commuter-related communications: a mobile communication gateway 154; a session management module 156; a chat management module 158; and an external service gateway 160.

The mass transit commuter connection system 100, in this example, further provides modules to facilitate presenting predictive geotargeted advertisements to commuters 102: a predictive locator module 162; a predictive geotargeted advertising module 164; and a web server 166 that serves an action item management interface 168. The mass transit commuter connection system 100 may also include a statistics engine 170 for compiling and analyzing commuter-related statistics.

These modules may be implemented as, for example, software modules executed by the computing devices of the system 100. It will be understood that the mass transit commuter connection system 100 may include additional or alternative modules to facilitate transit-related, commuter-related, and advertisement-related communications. The modules, in this example, will be discussed in further detail below.

As seen in FIG. 2, the mass transit commuter connection system 100 includes a data store 172 that stores various transit-related data, commuter-related data, and action item-related data. Transit-related data may include for example, transit system description data 174 and real-time transit data 176. Commuter-related data may include, for example, user profile data 178, user preference data 180, historical user data 182, session data 184, and interaction data 186. Action item-related data 188 may include the details of an action item such as, for example, a predictive geotargeted advertisement (e.g., business name, business address, content, etc.). Accordingly, where the action item is an advertisement, the action item-related data 188 may be referred to as advertisement data. It will be understood that the data store 172 may store additional or alternative types of data. The various types of data, in this example, will be discussed in further detail below.

The data store 172 may store the data in a database (e.g., an SQL database) that is managed by a database management system (not shown). The data store 172 may, for example, use a set of database tables having corresponding fields in order to store the transit-related, commuter-related, and advertisement-related data as a set of records with corresponding attributes. Additionally, relationships between the data in the data store may be established using, for example, key-value pairings. Additional or alternative approaches to storing the data may be selectively employed.

### Transit-Related Data

As mentioned above, the data store 172 of the mass transit commuter connection system 100 stores transit-related data. The mass transit commuter connection system 100, in this example, includes modules for obtaining and parsing information related to the mass transit system 104. The mass transit commuter connection system 100 may receive transit system description data 174 as well as real-time transit data 176 from a mass transit information system 116. Transit system description data 174, in this example, refers to information that describes one or more transit lines 112 of a mass transit system 104 including: the names of the transit lines of a mass transit system; the names of the respective transit stops along the routes for the transit lines; and the geographic location of the transit stops. Real-time transit data 176, in this example, refers to information relating to the current status of the mass transit system 104 including: the location of a vehicle along the route of a transit line 112; estimated arrival times; and customer alerts relating to a transit line, e.g., schedule changes, route detours, incidents affecting service, construction notices, and the like.

The mass transit commuter connection system 100 may retrieve the transit system description data 174 from the mass transit information system 116 over a network 106 (e.g., the Internet). The transit system description data 174 may be manually uploaded to the mass transit commuter connection system 100 or, additionally or alternatively, the system may be configured to automatically retrieve (i.e., download) the transit description data from the mass transit information system 116 at a periodic interval (e.g., every week, every month, etc.).

The transit system description data 174 may be formatted as GTFS data (General Transit Feed Specification). GTFS defines a common format for describing the schedule and geographic features of a mass transit system 104. A GTFS feed is a text-based description of the transit lines 112 and schedules of a mass transit system 104. A GTFS feed also describes the stops located along the route of a transit line 112. More information about the GTFS format may be available at https://developers.google.com/transit/gtfs/reference.

A GTFS-formatted description of a transit line 112 of a mass transit system 104 may include the following attributes: route_id; route_short_name; route_long_name; route_type; route_url; route_color; and route_text_color.

Accordingly, an example of a GTFS-formatted description with these example attributes of the CTA Red Line may be as follows:

[Red,“”,“Red
Line”,1,http://www.transitchicago.com/riding_cta/systemguide/redline.-
aspx,C60C30,FFFFFF].

Likewise, an example of a GTFS-formatted description with these example attributes of the CTA #151 bus line may be as follows:

[151,“151”,“Sheridan”,3,http://www.transitchicago.com/riding_cta/
busroute.aspx?RouteId=289,,].

A GTFS-formatted description of a stop along the route of a mass transit line 112 may include the following attributes: stop_id; stop_code; stop_name; stop_desc; stop_lat; stop_lon; location_type; parent_station; wheelchair_boarding.

Accordingly, an example of a GTFS-formatted description with these example attributes of a stop along the route for the CTA Red line may be as follows:

[17379,17379,“Belmont & Sheffield (Red/Brown/Purple Line)”,“Belmont
& Sheffield (Red/Brown/Purple Line), Eastbound, Southeast
Corner”,41.9398701,−87.65306242,0,,1].

Likewise, an example of a GTFS-formatted description with these example attributes of a stop along the route for the CTA #151 bus line may be as follows:

[1136,1136,“Lake Shore & Schiller”,“Lake Shore & Schiller, Northbound,
Eastside of the Street”,41.908064,−87.62576,0,,1].

As seen in these examples, the transit system description data 174 may include, for example: a unique identifier for each transit stop; a name for the transit stop; a description of the transit stop; and location information for the transit stop. The location information may be, for example, latitude and longitude coordinates. GTFS-formatted data for the CTA bus lines and rail lines, for example, may be available from http://www.transitchicago.com/downloads/sch_data/.

The transit system description data parsing module 150 receives this GTFS-formatted transit system description data 174 and parses the information from the transit system description data. The transit system description data parsing module 150, in this example, is in signal communication with the data store 172 and thus transmits the parsed transit system description data 174 to the data store for storage. The transit system description data parsing module 150, in this example, is also in signal communication with the real-time transit data collection module 152. Accordingly, the transit system description data parsing module 150 may receive real-time transit data 176 as supplemental data when parsing and storing the transit system description data 174.

The transit system description data 174 may also include sequence numbers for the transit stops along a route for a transit line 112 of a mass transit system 104. If the transit system description data 174 does not include sequence numbers for the transit stops, then the transit system description data parsing module 150 may derive sequence numbers for the transit stops during the data parsing process based on the location information of each transit stop. In this way, a sequential ordering of the stops along a route for a transit line 112 may be obtained and adjacent transit stops may be determined.

As seen in these examples, the descriptions of the mass transit system routes and stops include transit type information (e.g., bus or train), transit line information (e.g., rail line identifier and bus line identifier), and location information (e.g., latitude and longitude). As discussed further below, the mass transit commuter connection system 100 uses this transit system description data 174 when predicting the future locations of commuters 102 on the mass transit system 104.

The real-time transit data collection module 152 may retrieve real-time transit data 176 from a mass transit information system 116 over a network 106 (e.g., the Internet). The real-time transit data collection module 152, in this example, may be configured to automatically retrieve the real-time transit data 176 from the mass transit information system 116 at a periodic interval (e.g., every minute, every hour, etc.). The real-time transit data collection module 152, in this example, is also in signal communication with the data store 172 and transmits the real-time transit data 176 to the data store for storage. The real-time transit data collection module 152 may also parse the real-time transit data 176 received from the mass transit information system 116 and transmit the parsed real-time transit data to the data store 172 for storage.

The real-time transit data 176 may be received as, for example, XML-formatted data (eXtensible Markup Language). The real-time transit data 176 may include, for example, status-related information and alert-related information as mentioned above. More information about real-time transit information published by, for example, the CTA may be available from http://www.transitchicago.com/developers/alerts.aspx and http://www.transitchicago.com/developers/bustracker.aspx.

### Commuter-Related Data

Also mentioned above, the data store 172 of the mass transit commuter connection system 100 also stores commuter-related data. Commuter-related data includes information relating to the commuters 102 connected to the mass transit commuter connection system via a mobile application 108 running at a mobile device 110. Accordingly, commuter-related information may include, for example, user profile data 178, user preference data 180, historical user data 182, session data 184, and interaction data 186.

User profile data 178 may include, for example: a username for the commuter 102; and demographic information, e.g., age, sex, location. User profile data 178 may also include information related to linked accounts or external services (e.g., a Facebook account, a Twitter account, etc.) respectively associated with the commuters.

User preference data 180 may include, for example: information indicating the types of advertisements a commuter 102 would like to receive, e.g., food-related advertisements, drink-related advertisements, fashion-related advertisements, etc. User preference data 180 may also include information relating to user favorites, bookmarks, and custom application settings for application interaction, navigation, and information recall.

Historical user data 182 may include, for example: data subsets and summaries; data analysis results; information indicating responsiveness to advertisements; and total miles traveled. The data store 172 of the system 100 may store information indicating responsiveness to advertisements based on user interaction with an advertisement such as, for example, requests for further information relating to the advertisement. Advertisements may also be associated with a coupon or code displayable at or scannable by the business associated with the advertisement. When the coupon or code is displayed or scanned, the business may relay information back to the system 100, which may be stored in the data store 172 as historical user data 182. The system 100 may also monitor the location of a commuter 102 to determine whether the commuter 102 visits the business or event associated with the advertisement.

Session data 184 refers to information relating to the connection of the mass transit commuter connection system 100 to the mobile application 108 running at the mobile device 110 of the commuter 102. Session data 184 may include, for example: a unique identifier for the commuter 102; a unique identifier for the mobile device 110; a unique identifier for the mobile application 108 running at the mobile device 110; the transit type, transit line, and heading (i.e., direction) of the commuter; the current location of the commuter; and the next upcoming stop for the commuter.

The session management module 156 may manage the sessions associated with commuters 102 connected to the mass transit commuter connection system 100 via the mobile applications 108. The session management module 156 may create a new session for a commuter 102 when the commuter first connects to the mass transit commuter connection system 100 via the mobile application 108. The session management module 156 may also manage the communications exchanged between the mass transit commuter connection system 100 and the mobile application 108 at the mobile device 110. When the commuter 102 disconnects from the mass transit commuter connection system 100, the session management module 156 may remove the session for a commuter. The session management module 156, in this example, is in signal communication with the data store 172 and thus may transmit session data 184 to the data store 172 for storage.

The session management module 156, in this example, is also in signal communication with the mobile communication gateway 154, which serves as the entry point to the mass transit commuter connection system 100 for the mobile applications 108. The mobile communication gateway 154 may receive requests from a mobile application 108 over the network 106 and pass the request to the session management module 156 for processing. The session management module 156 may process the request, which may include passing the request to other modules for further processing. If the request from the mobile application 108 requires a response, the mobile communication gateway 154, in this example, transmits the response back to the mobile application 108 over the network 106. The mobile communication gateway 154 may also broadcast information to the mobile application 108 such as predictive geotargeted advertisements as discussed further below.

Interaction data 186 may include, for example, chat messages, video game status updates, and other types of information relating to the communications exchanged between commuters 102 connected via the mass transit commuter connection system 100. Communications exchanged between connected commuters 102 will be discussed in further detail below.

### Advertisement-Related Data

The data store 172 of the mass transit commuter connection system 100 may also store action item-related data 188 as mentioned above, which may be referred to as advertisement data when the action items are advertisements. The mass transit commuter connection system 100 may provide predictive geotargeted advertisements to commuters 102 traveling on a mass transit system 104 using the advertisement data 188.

Advertisement data 188 may describe both consumer deals, events, and commuter-generated advertisements in the style of newspaper or online “for sale ads.” For a consumer deal, the advertisement data 188 may include, for example: the name of the business offering the consumer deal; the business address; and a description of the consumer deal. For an event, the advertisement data 188 may include, for example: the name of the promoter for the event; the name of the event; and a description of the event. Advertisement data 188 may also include a set of time periods during which the deal or event is active (e.g., date range, active days, active times, etc.) as well as contact information for the deal or event (e.g., website, phone number etc.).

Users 190 (e.g., advertisers, businesses, event promoters, sales managers, commuters etc.) may access the action item management interface 168 to provide the advertisement data 188 to the mass transit commuter connection system 100 via an. Users 190 may include, for example, advertisers, businesses, event promoters, sales managers, commuters, and other types of users that may wish to create and configure action items (e.g., advertisements) associated with a transit stop for presentation to a commuter. Advertisers and businesses may selectively create and configure action items themselves, or a sales manager may create and configure the action items on behalf of other types of users.

The action item management interface 168 may be, for example, a set of web pages for creating and configuring an advertisement for a consumer deal or event. As seen in FIG. 2, a web server 166 may host the action item management interface 168, and a user 190 operating a computing device 192 may access the action item management interface via a network 106 (e.g., the Internet). The web server 166 may be in signal communication with the data store 172 and thus transmit the action item-related data 188 received from the user 190 via the action item management interface 168 to the data store for storage.

The computing device 192 may be, for example, a desktop computer, laptop computer, tablet computer, palmtop computer, mobile telephone, or any other network-enabled computing device. The computing device 192 may, for example, present the action item management interface 168 to the user 190 in a web browser residing at the computing device. Additionally or alternatively, the action item management interface 168 may be a stand-alone software application or software module residing at the computing device 192 that is in signal communication with the mass transit commuter connection system 100 via the web server 166 or the mobile communication gateway 154. The creation and configuration of advertisements for predictive geotargeted advertising will be discussed in further detail below.

### Connecting Mass Transit Commuters

The system 100 provided is a mass transit commuter connection system. In this regard, the system 100 may be described as connecting commuters 102 traveling on a common transit line 112 of a mass transit system 104. As an example, the CTA Red Line runs northbound to the Howard station and southbound to the 95th/Dan Ryan station. Accordingly, the northbound CTA Red Line and the southbound CTA Red Line may be considered as distinct transit lines 112. Likewise, the northbound CTA Blue Line and the southbound CTA Blue Line, the northbound CTA #151 bus line, and the southbound CTA #151 bus line may also each be considered to be distinct transit lines 112. Transit lines 112 may also be referred to according to their final destinations (i.e., end points or head signs): the “Howard Red Line” (northbound CTA Red Line); the “95th/Dan Ryan Red Line” (southbound CTA Red Line); the “151 to Union Station” (southbound CTA #151 bus line); the “151 to Clark/Devon” (northbound CTA #151 bus line); etc. In some example implementations, the system 100 may connect commuters 102 traveling on different transit lines 112 as mentioned above.

Accordingly, the mass transit commuter connection system 100 may be described as connecting commuters 102 traveling on the same transit type (e.g., bus line, rail line, etc.), on the same transit line 112 (e.g., CTA Red Line, CTA Blue Line, etc.), and in the same direction (e.g., northbound, southbound, eastbound, westbound)—i.e., a common transit line. As an example, a first set of commuters may be traveling northbound on the CTA Red Line (the “Howard Red Line”). Similarly, a second set of commuters may be traveling southbound on the CTA #151 bus (the “#151 to Union Station”). The mass transit commuter connection system 100 may connect the first set of commuters traveling on the Howard Red Line (the common transit line), and the mass transit commuter connection system may connect the second set of commuters traveling on the #151 bus to Union Station (the common transit line). In this way, commuters 102 traveling on a common transit line may share in the commuting experience by engaging in a variety of activities during travel. Activities may include, for example, chatting with fellow commuters, playing video games with fellow commuters, and the like.

One way in which the mass transit commuter connection system 100 may connect commuters 102 traveling on a common transit line 112 is via a chat room corresponding to the transit line and transit direction the commuters are traveling on. Accordingly, the chat rooms may be designated by the mass transit type, transit line, and transit direction. Using the examples above, the mass transit commuter connection system 100 may connect the first set of commuters via a “northbound CTA Red Line chat room” and connect the second set of commuters via a “southbound #151 bus chat room.” Commuter chat rooms will be discussed in further detail below.

Once a commuter 102 is connected to the mass transit commuter connection system 100 the mobile application 108 may periodically transmit (e.g., once a second) a signal to the system in order to maintain the connection with the system. The signal the mobile application 108 periodically transmits to the mass transit commuter connection system 100 may be referred to as a heartbeat signal. Accordingly, the session management module 156, in this example, maintains the session for the commuter 102 as long as the session management module receives the heartbeat signal from the mobile application 108 at the mobile device 110 of the commuter. If the session management module 156 does not receive the heartbeat signal for a predetermined time period (e.g., five minutes), the session management module 156 may determine that the commuter 102 has exited the mobile application 108 and remove the session for the commuter.

The heartbeat signal may include various types of status information relating to the commuter 102, the mobile application 108, and the mobile device 110. The heartbeat signal, in this example, includes information identifying the current geographic location of the commuter 102. The location-related information for the commuter 102 contained in the heartbeat may include, for example, an altitude, a heading, a horizontal accuracy, a latitude, a longitude, a speed, and a vertical accuracy. Accordingly, the mobile application 108 may transmit the heartbeat signal according to the following example format:

altitude=[altitidue]&heading=[heading]&horizontalAccuracy=[horizontal
accuracy]&latitude=[latitude]&longitude=[longitude]&speed[speed
]&verticalAccuracy=[vertical accuracy]

where the bracketed items are numerical values corresponding to the current geographic location of the commuter 102.

Accordingly, an example of a heartbeat signal may be as follows:

altitude=1.1&heading=1.1&horizontalAccuracy=1.1&latitude=41.980041
&longitude=−
87.658740&speed=1.1&verticalAccuracy=1.1

The mobile application 108 may receive the location-related information from hardware or other software (not shown) residing at the mobile device 110 such as, for example, a GPS module (Global Positioning System) and a compass. As seen in this example, the current geographic location of the commuter 102 may be identified using latitude and longitude coordinates. The mobile application 108 may format the location-related information according to the format above and transmit a heartbeat signal containing the location-related information to the mass transit commuter connection system 100.

In some situations, however, the mobile device 110 may not be able to determine its current geographic location and, as a result, may not be able to transmit location-related information identifying its current geographic location to the mass transit commuter connection system 100. For example, when a commuter 102 is traveling underground, on a subway for example, the GPS module at the mobile device 110 may not be able to access the GPS network. The mass transit commuter connection system 100 may be configured to accommodate these types of situations by employing alternative approaches to determining or at least estimating the current geographic location of the commuter 102. In one approach, the system 100 may infer the current geographic location from previous geographic locations of the commuter. According to another approach, the system 100 may pair the mobile device 110 with the vehicle on which the commuter 102 is traveling and obtain real-time transit data 176 (FIG. 2) corresponding to the vehicle from a mass transit information system 116. The system 100 may then infer the current geographic location of the commuter 102 based on the real-time transit data 176 associated with the vehicle on which the commuter is traveling. Additionally or alternatively, the mobile application 108 (FIG. 1) at the mobile device 110 may be configured to transmit to the system 100 readings from a compass sensor (not shown) at the mobile device. The system 100 may thus be configured to determine or at least estimate the current geographic location of the commuter 102 based on the compass sensor readings and corresponding unique magnetic fingerprints.

The mobile communication gateway 154, in this example, receives the heartbeat signal from the mobile application 108 and forwards it to the session management module 156. The session management module 156 may parse the location-related information from the heartbeat signal and update the session data 184 of the session with the received location-related information. In this way, the mass transit commuter connection system 100 may monitor the geographic location of commuters 102 as they travel on the mass transit system 104.

In some example implementations, the session management module 156 may be configured to determine when the commuter 102 has left the mass transit system 104. In one example implementation, the commuter 102 may provide user input at the mobile device 110 to disconnect from the mass transit commuter connection system 100, and the mobile application 108 may transmit a disconnect request to the system in response to receipt of the user input. The mobile communication gateway 154 may receive the disconnect request and forward the disconnect request to the session management module 156, which removes the sessions in response to receipt of the disconnect request.

In another example implementation, the mass transit commuter connection system 100 may automatically determine when a commuter 102 has left the mass transit system 104. In this example, the location-related information received in the heartbeat signal may be periodically compared to the locations of stops along the transit route for the transit line 112 the commuter 102 is traveling on. Based on the comparison of the current location of the commuter 102 to the respective locations of the stops along the route, the mass transit commuter connection system 100 may make a determination of whether the commuter is still traveling on the transit line 112. For example, if the system 100 determines that the current geographic location of a commuter 102 exceeds a predetermined distance (e.g., five hundred feet) from the route of a transit line 112, then the system may determine that the commuter has exited the transit line. If the mass transit commuter connection system 100 determines that the commuter 102 is not still traveling on the transit line 112, then the session management module 156 may disconnect the commuter from the system, e.g., by removing the session associated with the commuter.

As discussed further below, commuters 102 connected to the mass transit commuter connection system 100 may interact in various ways and receive predictive geotargeted advertisements.

### Determining Commuter Transit Information

In order to connect commuters 102, the mass transit commuter connection system 100, in this example, is configured to determine the type of mass transit system 104 a commuter is traveling on (e.g., bus, rail, etc.), the transit line 112 the commuter is traveling on (e.g., CTA Red Line, CTA #151 bus line, etc.), and the direction in which a commuter is traveling (e.g., northbound, southbound, toward Union Station, etc.). In other words, the mass transit commuter connection system 100 may be configured to determine the transit information for a commuter 102. The mass transit commuter connection system 100 may be configured to receive the transit information from the commuter 102 manually or the mass transit commuter connection system may be additionally or alternatively configured to automatically determine or estimate the transit information for the commuter.

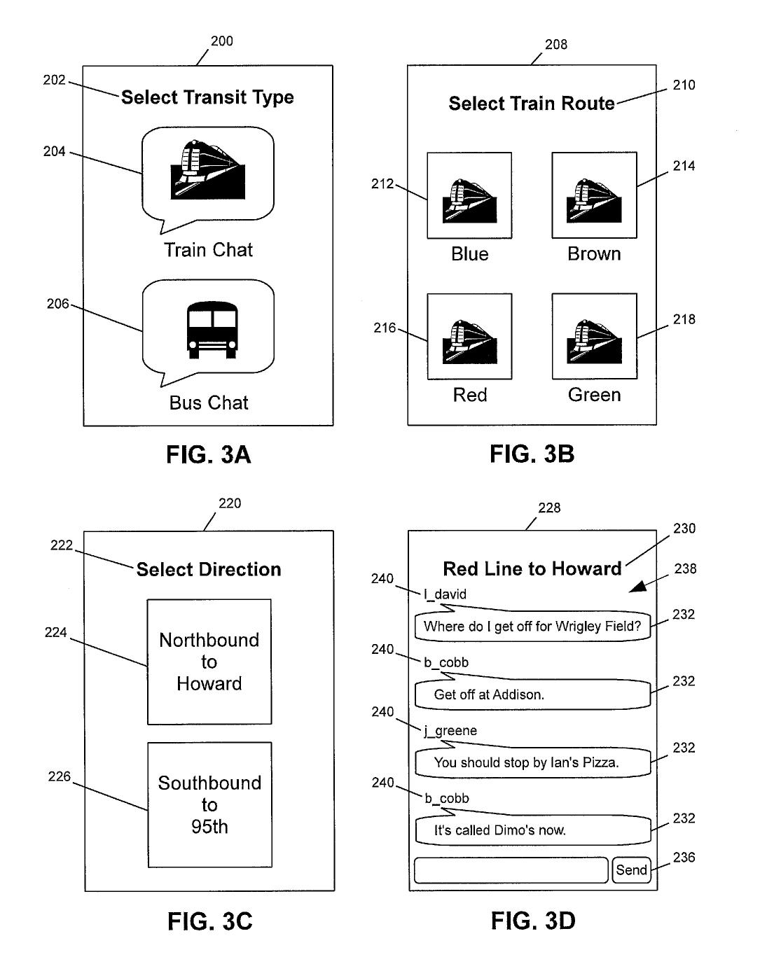

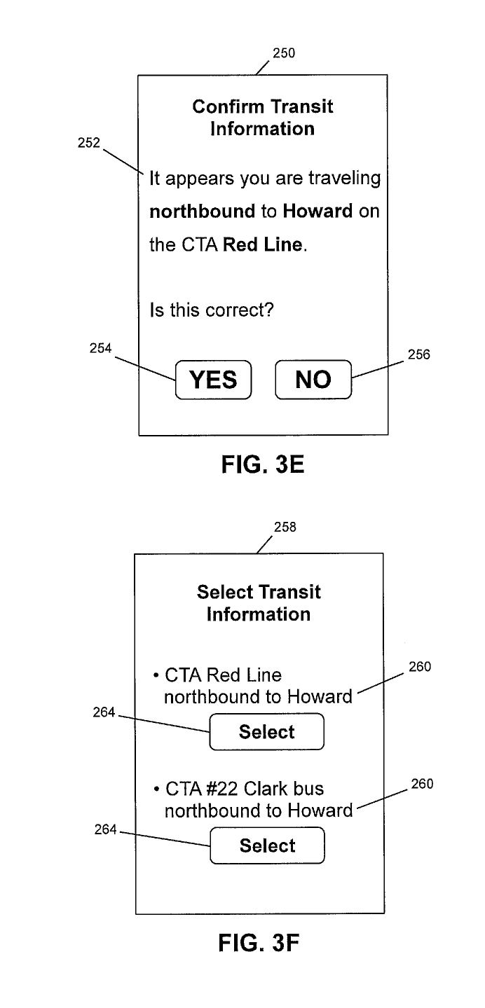

Referring to FIGS. 3A-C, examples of implementations of interfaces for manually receiving transit information from a commuter 102 are shown. The mobile application 108 running at the mobile device 110 of the commuter 102 may display the interfaces to the commuter, receive input from the commuter, and transmit the input to the mass transit commuter connection system 100. The session management module 156 may update the session data for the commuter 102 based on the transit information received in order to associate the commuter with a particular transit line 112 of a mass transit system 104.

As seen in FIG. 3A, the mobile application 108 may first present an interface 200 prompting the commuter 102 to select the mass transit type 202 the commuter is traveling on. In this example, the interface 200 includes two options 204 and 206 for the mass transit type 202: bus and rail. Once the commuter 102 has selected the mass transit type 202, the mobile application 108 may display a list of transit lines for the selected mass transit type 202. In this example, the commuter 102 has selected the rail option 204 as the type of mass transit system 104 the commuter is traveling on. Accordingly, as shown by way of example in FIG. 3B, the mobile application 108 may display an interface 208 prompting the commuter 102 select the transit line 210 (rail line in this example) that the commuter is traveling on. In this example, the interface 208 includes selections 212-218 for the Blue Line 212, Brown Line 214, Red Line 216, and Green Line 218.

Once the commuter 102 has selected the transit line 210, the mobile application 108 may display an interface 220 prompting the commuter 102 to select the direction 222 of travel. In this example, the commuter 102 has selected the Red Line 216. Accordingly, as shown by way of example in FIG. 3C, the mobile application 108 may display an interface 220 requesting that the commuter 102 indicate the direction 222 of travel: northbound to Howard 224 or southbound to 95th 226. The mobile application 108 may transmit the selections made by the commuter 102 to the mass transit commuter connection system 100 where the session management module 156 may update the session data 184 of the session for the commuter with the transit information. Having received the transit information from the commuter 102, the mass transit commuter connection system 100 may connect the commuter with other commuters traveling on the same transit line 112 in the same direction. Once connected, connected commuters 102 may interact by exchanging communications via the mobile application 108. As mentioned above, one type of interaction connected commuters 102 may engage in is chatting with one another while traveling on the mass transit system 104.

FIG. 3D is an example of an implementation of an interface 228 for a chat room 230 connecting commuters 102 traveling on a common transit line 112. In the example shown in FIG. 3D, each of the commuters 102 are traveling northbound on the Red Line to Howard. The commuters 102 may enter chat messages 232 into a textbox 234 and submit them to the chat room 230 via a “Send” button 236. The interface 228, in this example, displays a list 238 of the chat messages 232 received from the connected commuters 102. The mass transit commuter connection system 100 may be configured such that chatting with connected commuters 102 is anonymous. Accordingly, the mass transit commuter connection system 100 may only identify commuters 102 using a commuter-provided username 240. In this way, the mass transit commuter connection system 100 advantageously avoids the awkwardness or discomfort of interacting with strangers while traveling on a mass transit system 104.

As mentioned above, the mass transit commuter connection system 100 may be configured to automatically determine or estimate the transit information for a commuter 102. In this example, the predictive locator module 162 of the mass transit commuter connection system 100 may be configured to automatically determine or estimate the transit information for a commuter 102. The predictive locator module 162, in this example, is in signal communication with the session management module 156. Accordingly, the session management module 156 may forward location-related information received from the mobile application 108 to the predictive locator module 162. The predictive locator module 162 of the mass transit commuter connection system 100 may analyze the location-related information and automatically determine or estimate the current type of mass transit system 104, transit line 112, and direction of travel for a commuter 102.

The predictive locator module 162 may automatically determine or estimate the travel information for the commuter 102 by comparing the location-related information for the commuter to the transit system description data 174 stored in data store 172. In particular, the predictive locator module 162 may compare the location information received from the mobile application 108 corresponding to the geographic location of the commuter 102 to the geographic information for the transit stops of the transit line 112 the commuter is traveling on. In some example implementations, the predictive locator module 162 may selectively compare the current or historical and single or aggregated geographic locations of the commuter 102 to the geographic information for the transit stops. Based on the comparison of the commuter location information to the transit stop location information, the predictive locator module 162 may generate one or more estimated transit information results for the commuter 102. The predictive locator module 162 may forward the estimated transit information results back to the session management module 156, which may forward the results to the mobile communication gateway 154 for transmission back to the mobile application 108 and display to the commuter 102.

If the predictive locator module 162 identifies only one possible transit information result, then the system 100 may transmit the result to the mobile application 108, which may prompt the commuter 102 to confirm or deny the estimated transit information. FIG. 3E is an example of an implementation of an interface 250 that prompts the commuter 102 confirm or deny the estimated transit information 252. In this example, the estimated transit information 252 indicates that the predictive locator module 162 has estimated the commuter 102 is traveling northbound to Howard on the CTA Red Line. The commuter 102 may confirm or deny the estimated transit information 252 in this example by selecting the “YES” button 254 or the “NO” button 256 respectively. The mobile application 108 may transmit a confirmation of the estimated transit information 252 to the mass transit commuter connection system 100 where the session management module 156 may update the session data 184 of the session for the commuter 102 accordingly. Additional or alternative approaches to prompting the commuter 102 to confirm or deny estimated transit information 252 may be selectively employed.

If the predictive locator module 162 identifies multiple possible transit information results, then the system 100 may transmit the results to the mobile application 108, which may prompt the commuter 102 to select the correct estimated transit information from a list of the transit information results. FIG. 3F is an example of an implementation of an interface 258 that prompts the commuter 102 to select the correct transit information result 260 or 262 from a list of transit information results. In this example, the predictive locator module 162 has estimated that the commuter 102 is either traveling on the CTA Red Line northbound to Howard as indicated by the first transit information result 260 or the CTA #22 Clark bus northbound to Howard as indicated by the second transit information result 262. The commuter 102 may select the correct transit information result 260 or 262 in this example via one of the “Select” buttons 264. The mobile application 108 may transmit the selection to the mass transit commuter connection system 100 where the session management module 156 may update the session data 184 of the session for the commuter 102 accordingly. Additional or alternative approaches to prompting a commuter 102 to select an estimated travel information result may be selectively employed.

If none of the estimated transit information results are correct, then the commuter 102 may deny the one or more estimated travel information results. The mobile application 108 may transmit the denial to the mass transit commuter connection system 100 where the predictive locator module 162 may repeat the estimation procedure using, for example, updated location-related information received from the mobile application 108. Additionally or alternatively, the mobile application 108 may request that the commuter 102 manually provide the transit information as described above with reference to FIGS. 3A-C if none of the estimated travel information results are correct.

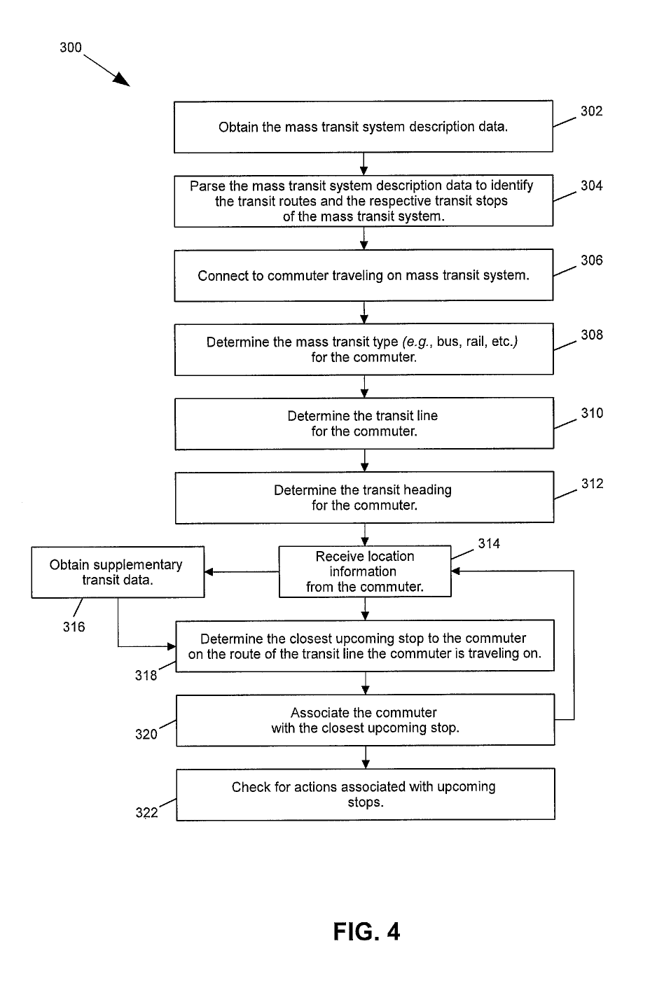

In FIG. 4, a flowchart 300 of example method steps for connecting commuters traveling on a common transit line 112 of a mass transit system 104 is shown. The mass transit commuter connection system 100 may obtain transit system description data 174 (e.g., GTFS data) for a mass transit system 104 (step 302). A transit system description data parsing module 150 may parse the transit system description data 174 to populate a data store 172 with information that identifies the transit lines 112 of the mass transit system 104 and the respective transit stops of the transit lines (step 304). As discussed above, the transit system description data 174 may be obtained from a mass transit information system 116 provided by a transit authority (e.g., the CTA) that operates the mass transit system 104.

A commuter 102 traveling on the mass transit system 104 may connect to the mass transit commuter connection system 100 (step 306) via a mobile application 108 running at a mobile device 110. The mass transit commuter connection system 100 may determine the type of mass transit system 104 (step 308), may determine the transit line 112 (step 310), and may determine the heading (step 312) for the commuter 102 traveling on the mass transit system.

Once the travel information for the commuter 102 has been determined, the mass transit commuter connection system 100 may receive current location-related information from the commuter (step 314). As discussed above, the current location-related information may be received in a heartbeat signal transmitted by the mobile application 108 running at the mobile device 110 operated by the commuter 102. The mass transit commuter connection system 100 may also obtain supplemental transit data in order to aid in the identification and verification of the travel information of the commuter (step 316). Supplementary transit data may include, for example, real-time transit data 176 received from a mass transit information system 116; historical user data 182 such as, e.g., previous locations, previous associated stops, etc. As mentioned above, the real-time transit data 176 may relate to the current status of the transit line 112 of the mass transit system 104 the commuter 102 is traveling on (e.g., alerts, arrival times, etc.). The predictive locator module 162, in this example, is in signal communication with the real-time transit data collection module 152. In this way, the predictive locator module 162 may use the real-time transit data 176 as supplemental information when determining the travel information for a commuter 102.

Once the mass transit commuter connection system 100 determines the travel information for the commuter 102 and the current location of the commuter, the mass transit commuter connection system may determine the next upcoming stop for the commuter (step 318). The next upcoming stop, in this example, refers to the next stop along the route of the transit line 112 the commuter 102 is traveling on. In most circumstances, the next stop for the commuter will be the closest upcoming stop along the route of the transit line the commuter is traveling on. In some circumstances, however, the closest upcoming stop may not be the next stop. For example, the route for the transit line 112 may turn or bend such that the geographically closest upcoming stop is not the actual next stop for the transit line. Accordingly, the transit description data may be taken into account when determining the next stop for the commuter. In this example, the predictive locator module 162 may determine the next upcoming stop for the commuter 102.

Once the next upcoming stop for the commuter 102 is determined, the predictive locator module 162, in this example, may associate the commuter with the next upcoming stop (step 320). The predictive locator module 162, in this example, may associate the commuter 102 with the next upcoming stop by creating a relationship between the user profile for the commuter and the stop of the transit line stop in the data store 172. A key-value pairing may be employed to establish the relationship between the commuter user profile and the transit line stop (e.g., commuter.upcoming_stop=stop.stop_id). Additional or alternative approaches may be selectively employed for associating a commuter 102 with the next upcoming stop or establishing a relationship between the commuter user profile and the transit line stop in the data store 172.

Transit stops may be respectively associated with action items. Action items may include, for example, transmitting an alert associated with the transit stop or transmitting a predictive geotargeted advertisement associated with the transit stop. Action items may also include, for example, displaying various types of information relating to the transit stop and the surrounding geographical area. Such information may include, for example, police or crime data, news, postings, historical data, trivia, ratings or reviews, events, transit stop usage statistics, travel conditions, delay information, average trip duration or distance, user behavior, transit reliability, and comparisons of the transit stop relative to other transit stops. The data store 172 may store and maintain the action item-related data 188 corresponding to these alternative types of action items. The information displayed for a transit stop may be selectively obtained, for example, from the mass transit commuter connection system 100 itself or a third party system 194. Once a commuter 102 is associated with the next upcoming stop, the mass transit commuter connection system 100 may determine if any actions associated with the next upcoming stop or other upcoming stops should be performed (step 322).

Alerts, advertisements, and other types of action-related items may similarly be associated (e.g., via key-value pairing) with transit stops along the route of a transit line 112. By associating the information items in the data store 172 with one another, the system 100 advantageously provides a relatively quick and easy way to identify information associated with the transit stops.

### Connected Commuter Interactions

Once the mass transit commuter connection system 100 has connected commuters 102 traveling on a mass transit line 112, the commuters may interact to engage in a variety of activities. Interactive activities may include, for example, chatting, playing video games, sharing media content (e.g., videos and images), and providing feedback relating to physical aspects of the transit line 112 (e.g., graffiti, needed repairs, etc.) or feedback relating to the mass transit commuter connection system 100. The mass transit commuter connection system 100 and mobile application 108 may be configured to provide additional or alternative types of interactive activities.

As discussed above with reference to FIG. 3D, commuters 102 may be connected via a chat room 230 corresponding to the common transit line 112 the commuters are currently traveling on. A first commuter 102 connected to the mass transit commuter connection system 100 may input a chat message 232 at the mobile application 108 in the chat room 230 corresponding to the transit line 112 the commuter is traveling on. The mobile application 108 may transmit the chat message 232 to the mass transit commuter connection system 100. The mobile communication gateway 154 of the system 100 may receive the incoming chat message 232 and forward the chat message to the session management module 156 for processing. In some example implementations, the mass transit commuter connection system 100 may provide chat rooms based on additional or alternative criteria. For example, a subset of related commuters traveling on a common transit line 112 or different transit lines may be grouped together according to a shared characteristic (e.g., Chicago White Sox fans, Chicago Cubs fans, etc.) and may be associated with a chat room for that group (e.g., a Chicago White Sox fan chat room, a Chicago Cubs fan chat room, etc.).

In this example, the session management module 156 is in signal communication with a chat management module 158, and the chat management module is in signal communication with the data store 172. Accordingly, the chat management module 158, in this example, stores the chat message 232 at the data store 172 as interaction data 186. The interaction data 186 for chat messages 232, in this example, may include the content of the chat message as well as information identifying the source of the chat message, e.g., the chat room 230 the chat message is associated with, the username 240 of the commuter 102 that submitted the chat message, and timestamp for the chat message.

A second commuter 102 traveling on the same transit line 112 may be connected to the first commuter via the chat room 230 corresponding to the transit line. The mobile application 108 on the mobile device 110 of the second commuter 102 may submit a request to update the chat room 230 to the mass transit commuter connection system 100. The mobile communication gateway 154 may receive the chat update request, and the chat management module 158 may process the chat update request. The chat management module 158 may query the data store 172 for interaction data 186 (i.e., chat messages 232) associated with the chat room 230 corresponding to the transit line 112 the commuters 102 are traveling on. The data store 172 may return a chat message result set containing one or more chat messages 232. The chat messages 232 may be transmitted back to the mobile application 108 operated by the second commuter 102 in a response via the mobile communication gateway 154. The mobile application 108 on the mobile device 110 of the second commuter 102 may update the interface 228 of the chat room 230 to display the chat messages 232 received in the response. The mobile application 108 may be configured to periodically submit a request for new chat messages 232 (e.g., every minute) in order to receive the most recent chat messages 232 for the chat room 230.

In general, the mobile application 108, in this example, may communicate with the mass transit commuter connection system 100 via a request-response approach. As another example, the request-response approach may be employed to provide interactive gaming services to commuters 102 traveling on a common transit line 112 or different transit lines. The mobile application 108 may include one or more video game modules. Accordingly, connected commuters 102 may interact with one another as video game opponents. The mass transit commuter connection system 100, in this example, may exchange video game-related communications between the respective mobile applications 108 as a series of requests and corresponding responses. As mentioned above, the mass transit commuter connection system may connect commuters traveling on different transit lines. In this regard, video game modules may be provided to set up commuters 102 traveling on different transit lines 112 as opponents. For example, a video game module may pit commuters 102 traveling on the CTA Red Line against commuters 102 traveling on the CTA Blue Line. In this way, the mass transit commuter connection system 100 may foster competition among commuters 102 of different transit lines 112.

It will be understood that the mass transit commuter connection system 100 may be configured to facilitate additional or alternative types of interactive activities between connected commuters 102. As mentioned above, the mass transit commuter connection system 100 may include an external service gateway 160. The external service gateway 160 may provide an application programming interface (API) defining the protocol to access the mass transit commuter connection system 100. API requests may be received from mobile devices 110 as well as from third-party systems 194. Accordingly, the external service gateway 160 may receive API requests from the mobile application 108 running at the mobile device 110, an add-on module 114 within the mobile application 108, third party applications running at the mobile device 110, or third-party systems 194 over a network 106 such as the Internet. The external service gateway 160 may be in signal communication with the mobile communication gateway 154 in order to process API requests received from mobile devices 110. The external service gateway 160 may also be in signal communication with the session management module 156 and the data store 172 to access transit-related and commuter-related information when processing API requests.

Also mentioned above, the mobile application 108 at the mobile device 110 of a commuter 102 may include one or more add-on modules 114. An add-on module 114 may access the mass transit commuter connection system 100 via the API provided by the external service gateway 160. An add-on module 114 may extend the functionality or features provided by the mobile application 108 and use the API of the external service gateway 160 to access the data store 172 at the mass transit commuter connection system 100. An add-on module 114 may be developed by a third-party to provide additional interactive activities for commuters 102 traveling on a common transit line 112.

The mass transit commuter connection system 100 may also use the external service gateway 160 to access third-party systems 194 such as, for example, social networking systems (e.g., Facebook, Twitter, GoogleMaps, etc.). The mass transit commuter connection system 100 may compile and store information received from the third-party systems 194. In this way, the mass transit commuter connection system 100 may share transit-related, commuter-related, and advertisement-related information with third-party systems 194.

Additionally, the mass transit commuter connection system 100 may include a statistics engine 170 in signal communication with the external service gateway 160 and the data store 172. The statistics engine 170 may query the data store 172 for commuter-related information and analyze the commuter-related information to obtain commuter-related statistics pertaining to the commuters 102 that connect to the mass transit commuter connection system 100. The commuter-related statistics may be stored in the data store 172 as historical user data 182 and be formatted as, for example, tables, plots, graphs, maps, etc. when displayed. Commuter-related statistics 182 may include, for example, travel conditions, delays, transit stop usage, average trip duration, average trip distance, user behavior, and transit reliability. The commuter-related statistics 182 may be based on both perceived data and measured data.

A third-party system 194 may access the statistics engine 170 via the API provided by the external service gateway 160. In this way, third-parties may obtain the commuter-related statistics 182 over a network 106 (e.g., the Internet). Third-parties may include, for example, transit agencies, consumer advocacy groups, news and information reporting agencies, government agencies, and commuter-travel related websites, services, and companies. In this way, third-parties may utilize the mass transit commuter connection system 100 to provide policy or structural improvements.

### Predictive Geotargeted Advertising

As demonstrated above, commuters 102 traveling on a mass transit system 104 proceed in a particular direction toward a discrete set of stops on a transit line 112. As a result, the mass transit commuter connection system 100, in this example, can determine the current geographic location of a commuter 102 as well as predicted future geographic locations of the commuter. Predicting the future geographic locations of a commuter 102 enables the mass transit commuter connection system 100 to present to the commuter advertisements associated with those future locations. Presenting advertisements to commuters based on predicted future geographic locations of the commuters 102 may be referred to as predictive geotargeted advertising. Accordingly, the predictive geotargeted advertising module 164 is a module that identifies and selects one or more advertisements for presentation to a commuter based on one or more predicted future geographic locations of the commuter, i.e., where the commuter is predicted to be geographically located at a future time.

The predictive geotargeted advertising module 164, in this example, identifies advertisements associated with the next upcoming stop for the commuter 102 and selects one or more of the advertisements to present to the commuter at the mobile application 108. Accordingly, the predictive geotargeted advertising module 164, in this example, is in signal communication with the session management module 156, the predictive locator module 162, and the data store 172 to carry out the predictive geotargeted advertising process.

As mentioned above, the mass transit commuter connection system 100 associates a commuter 102 with the next upcoming stop for the commuter as the commuter travels along the route of the transit line 112. Accordingly, the predictive locator module 162 is a module that predicts one or more future geographic locations of the commuter 102 based on the current geographic location of the commuter, the transit line 112 on which the commuter is traveling, and the direction in which the user is traveling. The predictive locator module 162, in this example, determines the next upcoming stop for the commuter 102 as mentioned above.

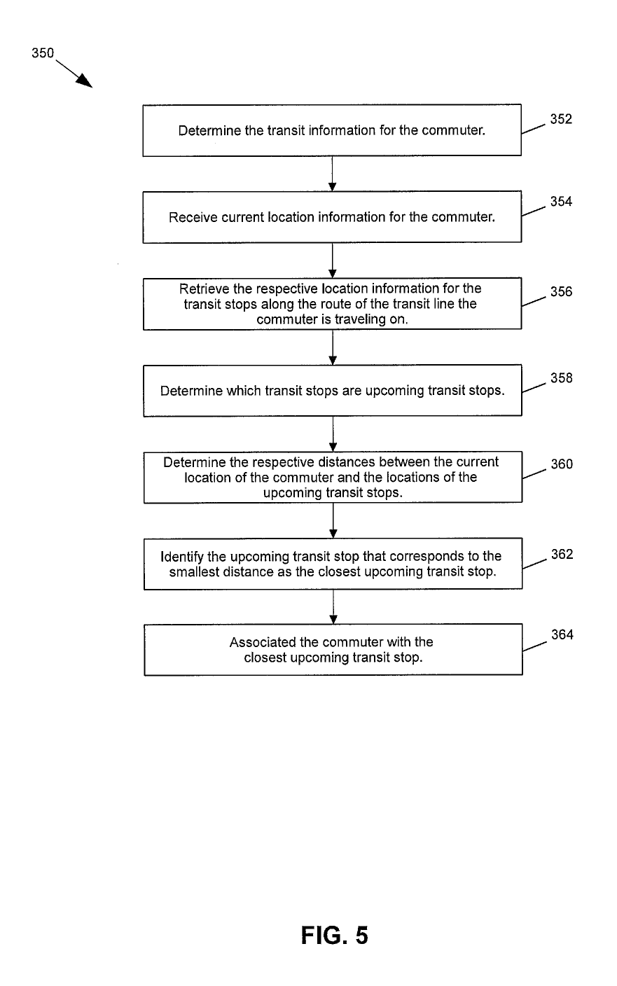

FIG. 5 is a flowchart 350 of example method steps for determining the next upcoming stop for a commuter 102. The mass transit commuter connection system 100 may first determine the transit information for the commuter 102 as discussed above, e.g., the type of mass transit system 104, the transit line 112, and the direction of travel (step 352). The mass transit commuter connection system 100 may then receive the current geographic location of the commuter 102 in the heartbeat signal transmitted by the mobile application 108 as discussed above (step 354).

The predictive locator module 162 may then query the data store 172 to retrieve the transit system description data 174 for the transit line 112 the commuter 102 is traveling on, which includes respective location information for the transit stops associated with the transit line (step 356). The predictive locator module 162 may then determine which transit stops along the transit line 112 are upcoming stops (step 358). The predictive locator module 162 may determine which transit stops are upcoming transit stops based on the current geographic location of the commuter 102 and the information indicating the direction of travel of the commuter. If a transit stop is located in the direction of travel for the commuter 102, i.e., ahead of the commuter, then the predictive locator module 162 may determine that the transit stop is an upcoming transit stop. If a transit stop is not located along the direction of travel for the commuter 102, i.e., behind the commuter, then the predictive locator module 162 may determine that the transit stop is not an upcoming transit stop. As an example, if a commuter 102 is traveling northbound, the predictive locator module 162 will determine that transit stops located northward of the current geographic location of the commuter 102 are upcoming stops and that transit stops located southward of the current geographic location of the commuter are not upcoming stops.

The predictive locator module 162 may then calculate the respective distances between the current geographic location of the commuter 102 and the locations of the upcoming transit stops (step 360). As discussed above, the current commuter location and the transit stop locations may be identified using latitude and longitude coordinates. Accordingly, the predictive locator module 162, in this example, may calculate the respective distances between the current commuter location and the locations of the upcoming transit stops based on the latitude and longitude coordinates. The predictive locator module 162 thus identifies the transit stop corresponding to the smallest calculated distance as the next upcoming stop (step 362). The predictive locator module 162 may then associate the commuter 102 with the next upcoming stop (step 364) as discussed above, e.g., using a key-value pairing in the data store 172.

As the commuter 102 travels along the transit line 112 of the mass transit system 104, the mass transit commuter connection system 100 periodically receives updated location information from the mobile application 108. Accordingly, steps 354-364 may be repeated to reassociate the commuter 102 with the new upcoming transit stops during travel along the transit line 112. It will be understood that additional or alternative approaches may be selectively employed to determine the next upcoming stop for the commuter 102.

Also mentioned above, stops along a route of a transit line 112 may be stored in the data store 172 with a sequence number. Accordingly, the predictive locator module 162 may determine additional upcoming stops for a commuter 102. The predictive locator module 162 may thus query the data store 172 for the stops along the transit line 112 the commuter 102 is traveling on, order the stops in the result set by sequence number, and identify the stops along the transit line sequentially located after the next upcoming stop for the commuter. In this way, the predictive locator module 162 may not only determine the next upcoming stop for the commuter 102, but subsequent upcoming stops as well. The system 100 may also utilize supplemental transit data (e.g., real-time transit data 176, historical user data 182, etc.) in order to aid in the identification and verification of upcoming stops.

The predictive locator module 162 may use the subsequent sequential upcoming stops when updating the next upcoming stop for the commuter 102 as the commuter travels along the transit line 112 of the mass transit system 104. For example, instead of calculating the distances each time the current geographic location of the commuter 102 is received, the predictive locator module 162 may alternatively identify the transit stop located sequentially after the next upcoming transit stop when the predictive locator module determines that the commuter has passed the transit stop currently identified as the next upcoming stop.

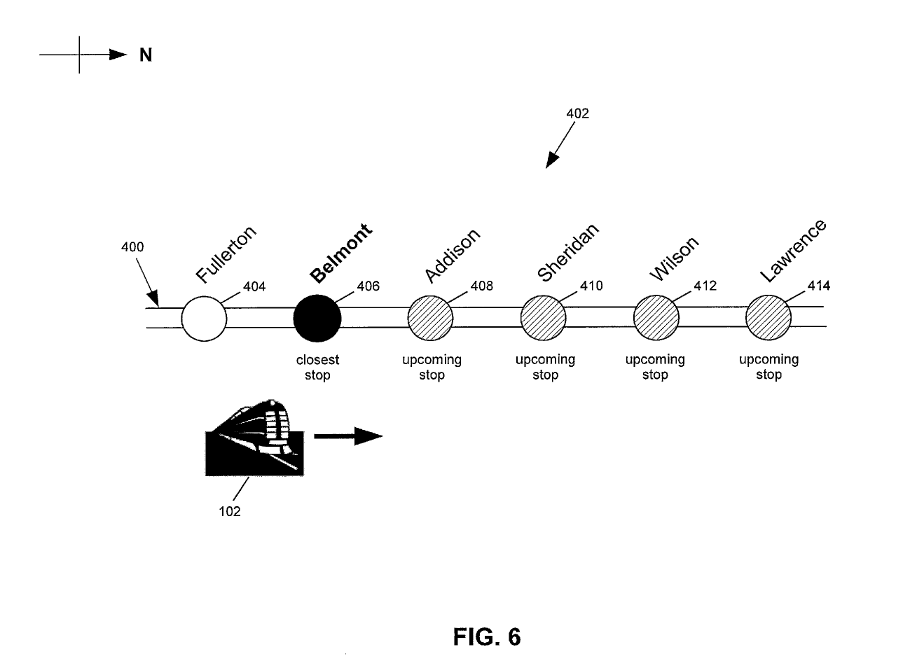

Referring to FIG. 6, a diagram of a portion of an example rail line 400 of a rail line transit system 402 is shown. Example stops 404, 406, 408, 410, 412, and 414 along the rail transit line 400 are shown in FIG. 6. In this example, a commuter 102 is traveling on the rail line 400 and located between the Fullerton stop 404 and the Belmont stop 406 traveling northbound. Accordingly, the Fullerton stop 404, in this example, is not located along the direction of travel for the commuter 102 as the commuter is traveling northbound and the Fullerton stop is located southbound of the current geographic location of the commuter. Similarly, the Belmont stop 406, Addison stop 408, Sheridan stop 410, Wilson stop 412, and Lawrence stop 414 are located along the direction of travel for the commuter 102 as these transit stops are located northbound of the current geographic location of the commuter.

Based on the current geographic location of the commuter 102 and the direction of travel, the predictive locator module 162 may identify the Belmont stop 406 as the next upcoming stop. In FIG. 6, the Belmont stop 406 is designated as the next upcoming stop using a solid black shading. Additionally, the sequence numbers in the transit system description data 174 for the rail line 400, in this example, may indicate that the Belmont stop 406 is sequentially followed by the Addison stop 408, Sheridan stop 410, Wilson stop 412, and Lawrence stop 414 respectively. Accordingly, the predictive locator module 162 may identify these stops 408, 410, 412, and 414 as subsequent upcoming stops after the Belmont stop 406. In FIG. 6, the subsequent upcoming stops 408, 410, 412, and 414 are designated using a cross-hatched shading.

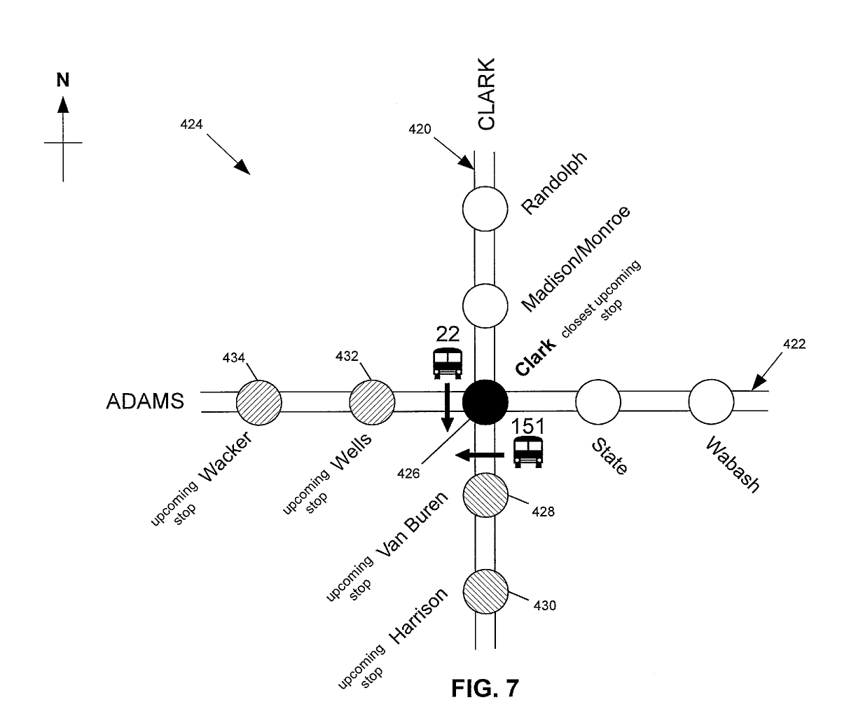

Referring to FIG. 7, a diagram of a portion of two respective bus transit lines 420 and 422 of a bus transit system 424 are shown. Transit stops along the respective bus transit lines 420 and 422 are shown to illustrate the advantages of determining the direction of travel for a commuter. In FIG. 7, the CTA #22 bus is traveling southbound on Clark street, and the CTA #151 bus is traveling westbound on Adams street. In this example, the CTA #22 bus and the CTA #151 bus share the transit stop 426 at the intersection of Clark street and Adams street.

The predictive locator module 162 has identified, in this example, the Clark-Adams transit stop 426 as the next upcoming stop for both the CTA #22 bus and the CTA #151 bus. Because the predictive locator module 162, in this example, has determined that a commuter 102 on the CTA #22 Clark bus is traveling southbound, however, the predictive locator module can identify the Van Buren stop 428 and the Harrison stop 430 on Clark street as subsequent upcoming stops for the commuter on the CTA #22 bus. Similarly, because the predictive locator module 162, in this example, has determined that a commuter 102 on the CTA #151 bus is traveling westbound, the predictive locator module can identify the Wells stop 432 and the Wacker stop 434 on Adams street as subsequent upcoming stops for the commuter on the CTA #151 bus. In this way, the mass transit commuter connection system 100 may perform actions that are not only associated with the current geographic location of a commuter 102, but actions that are associated with predicted future geographic locations of the commuter as well.

Using the example shown in FIG. 7, if the predictive locator module 162 predicts that a commuter 102 is traveling towards the Harrison stop 430 on the #22 Clark bus, then the system 100 may transmit an advertisement associated with the Harrison stop to the mobile application 108 on the mobile device 110 operated by the commuter. In this way, commuters 102 may advantageously receive advertisements for businesses or events located within the current or future geographic vicinity of the commuters. As mentioned above, this process may be referred to as predictive geotargeted advertising.

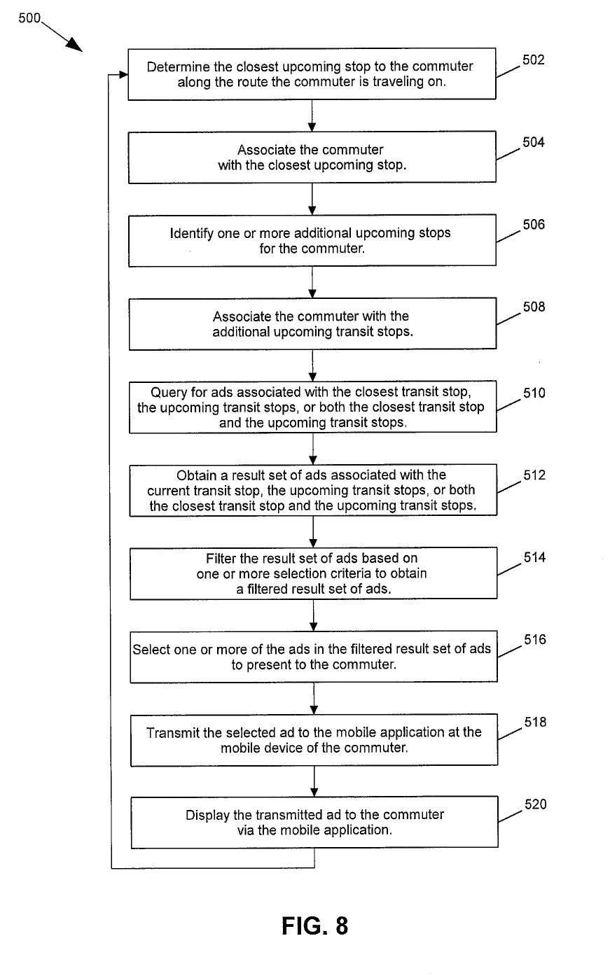

Referring to FIG. 8, a flowchart 500 of example method steps for presenting predictive geotargeted advertisements to a commuter 102 traveling on a transit line 112 of a mass transit system 104 is shown. First, the predictive locator module 162 of the mass transit commuter connection system 100 determines the next upcoming stop to the commuter 102 along the route of the transit line 112 the commuter is traveling on (step 502) and associates the commuter with the next upcoming stop (step 504). In some example implementations, the predictive locator module 162 may identify additional subsequent upcoming stops for the commuter 102 (step 506) and associate the commuter with the additional upcoming stops (step 508).

Once a commuter 102 is associated with the next upcoming stop, the predictive geotargeted advertising module 164 may query the data store 172 for advertisements associated with the next upcoming stop, subsequent upcoming stops, or both the next and subsequent upcoming stops (step 510). As mentioned above, advertisements may be stored in the data store 172 as advertisement data 188 and associated with a transit stop using a key-value pairing (e.g., advertisement.stop_id=stop.id) between the advertisement data and the transit system description data 174. Accordingly, the predictive geotargeted advertising module 164 may retrieve the advertisements associated with a transit stop relatively easily and quickly based on the key-value pairing between the advertisement and the transit stop in the data store 172. Additional or alternative methods may be selectively employed to associate the advertisements with a transit stop in the data store 172. An advertisement may be associated with multiple transit stops of multiple transit lines 112. The mass transit commuter connection system 100 may determine the transit stops associated with an advertisement when the advertisement is created, i.e., when a user 190 confirms the creation of a new advertisement. The system 100 may also determine the transit stops associated with an advertisement when a user 190 updates an advertisement.

In response to the query for advertisements associated with the next upcoming stop, the data store 172 may return a result set of one or more advertisements associated with the next upcoming stop or the additional upcoming stops (step 512). In some example embodiments, the predictive geotargeted advertising module 164 may filter the result set (step 514) in order to narrow the potential advertisements that may be presented to a commuter 102.

The predictive geotargeted advertising module 164 may filter the result set of advertisements based on a predetermined criterion, i.e., a filtering criterion, in order to obtain the filtered result set of advertisements. One or more filtering criteria may be employed to filter the result set of advertisements. The filtering criteria may be based on, for example, the user preference data 180 associated with the commuter 102, the user profile data 178 associated with the commuter, or the historical user data 182 associated with the commuter. As an example, if the commuter 102 has indicated via the user preference data 180 that the commuter is interested in food-related advertisements, then the predictive geotargeted advertising module 164 may filter the result set of advertisements such that the filtered result set of advertisements only includes food-related advertisements.

The predictive geotargeted advertising module 164 may select one of the advertisements in the result set (or filtered result set) to present to the commuter 102 (step 516). The predictive geotargeted advertising module 164 may, in some examples, randomly select one of the advertisements for presentation to the commuter 102. Additionally or alternatively, the predictive geotargeted advertising module 164 may select one of the advertisements based on a predetermined criterion, i.e., a selection criterion. Like the filtering criteria discussed above, selection criteria may be based on user profile data 178, user preference data 180, and historical user data 182 associated with the commuter 102. As an example, if the historical user data 182 associated with a commuter 102 indicates that the commuter consistently responds to food-related advertisements for pizzerias, then the predictive geotargeted advertising module 164 may select an advertisement for a pizzeria from the advertisement result set for presentation to the commuter. Selection criteria based on user profile data 178 and user preference data 180 may be employed in a similar fashion to select an advertisement to present to the commuter.

Additionally, the predictive geotargeted advertising module 164 may employ information obtained from a third-party system 194 when filtering a result set of advertisements or selecting an advertisement to present to the commuter 102. As mentioned above, the external service gateway 160 may be in signal communication with a third-party system 194. The third-party system 194 may be, for example, a social networking service (e.g., Facebook, Twitter, etc.) at which the commuter 102 has created a user profile. The external service gateway 160 may retrieve information about the commuter 102 from these types of third-party systems 194, and the predictive geotargeted advertising module 164 may use the information obtained from the third-party systems to filter and select advertisements for the commuter. The external service gateway 160 may be configured to access these third-party systems 194 via APIs respectively provided by the third-party systems.

Once the predictive geotargeted advertising module 164 has selected an advertisement for presentation to the commuter 102, the mass transit commuter connection system 100 may transmit advertisement data 188 associated with the advertisement to the commuter via the mobile communication gateway (step 518). The mobile application 108 at the mobile device 110 operated by the commuter 102 may receive the advertisement data 188 and display at least a portion of the advertisement data to the commuter via the mobile application (step 520).

The predictive geotargeted advertising module 164 may generate a link that may display more of the advertisement data 188 associated with the selected advertisement when the link is selected. The mass transit commuter connection system 100 may transmit the link to the mobile application 108 in a heartbeat response signal. The link may include information relating to the advertisement and the stop associated with the advertisement.

An example of a link for an advertisement may be as follows:

http://api.transitchatter.com/mobile_announcements/deal.php?ad_id=
281&stop_name=Belmont&stop_lat=41.9398701&stop_lon=−
87.65306242&stop_id=17379

where “ad_id” is a unique identifier for the selected advertisement; “stop_name” is the name of the transit stop associated with the advertisement; “stop_lat” is the latitude coordinate for the stop associated with the advertisement; “stop_lon” is the longitude coordinate for the stop associated with the advertisement; and “stop_id” is a unique identifier for the stop associated with the advertisement.

This advertisement link may be included in a heartbeat response signal, which may include additional information relating to the advertisement and the transit stop, i.e., advertisement data 188 and transit system description data 174. An example of a heartbeat response containing the advertisement link for the advertisement may be as follows:

{“id”:“281”,“message”:“$0.10 Buffalo
Wings”,“external_link”:“http://www.pj.mc.doogles”,“type”:“deal”,
“stop_name ”:“Belmont & Sheffield”,“entity_name”:“P.J.
McDoogles”,“stop_id”:“17379”,“stop_lat”:“41.9398701”,“stop_lon”:“−
87.65306242”,“has_ad”:“true”,“internal_link”:
“http://api.transitchatter.com
/mobile_announcements/deal.php?ad_id=281&stop_name=
Belmont&stop _lat=41.9398701&stop_lon=−
87.65306242&stop_id=17379”,“next_stop”:“Belmont &
Sheffield”,“pop”:1}

where “id” is a unique identifier for the advertisement; “message” is the descriptive content of the advertisement; “external_link” is a website for the business associated with the advertisement; “type” indicates the advertisement type (e.g., deal, event, etc.); “stop_name” is the name of the transit stop associated with the advertisement; “entity_name” is the name of the business associated with the advertisement; “has_ad” is a boolean value indicating that the heartbeat response signal includes an advertisement; “internal_link” is the advertisement link as discussed above; “next_stop” is the name of the next upcoming stop to the commuter; and “pop” is the current population of a chat room 230 the commuter 102 is associated with.

The heartbeat response signal, in this example, also includes the location information (e.g., latitude and longitude coordinates) for the transit stop associated with the advertisement as explained above. It will be understood that the heartbeat response may include additional or alternative advertisement data 188 and transit system description data 174 relating to the advertisement and the transit stop associated with the advertisement.

The mass transit commuter connection system 100 may also transmit a heartbeat response signal to the mobile application 108 even when no advertisement has been selected for presentation to the commuter 102. An example of a heartbeat response signal that does not include an advertisement may be as follows:

{“has_ad”:“false”,“next_stop”:“Bryn Mawr”,“pop”:1}

where “has_ad” is a boolean value indicating the heartbeat response signal does not include an advertisement.

As the commuter 102 travels along the route of the transit line 112, the predictive locator module 162 of the mass transit commuter connection system 100 may continually update the next upcoming stop for the commuter 102 as discussed above. Accordingly, the mass transit commuter connection system 100 may repeat steps 502-520 in order to present multiple predictive geotargeted advertisements to the commuter 102 as the commuter travels on the transit line 112 of the mass transit system 104.

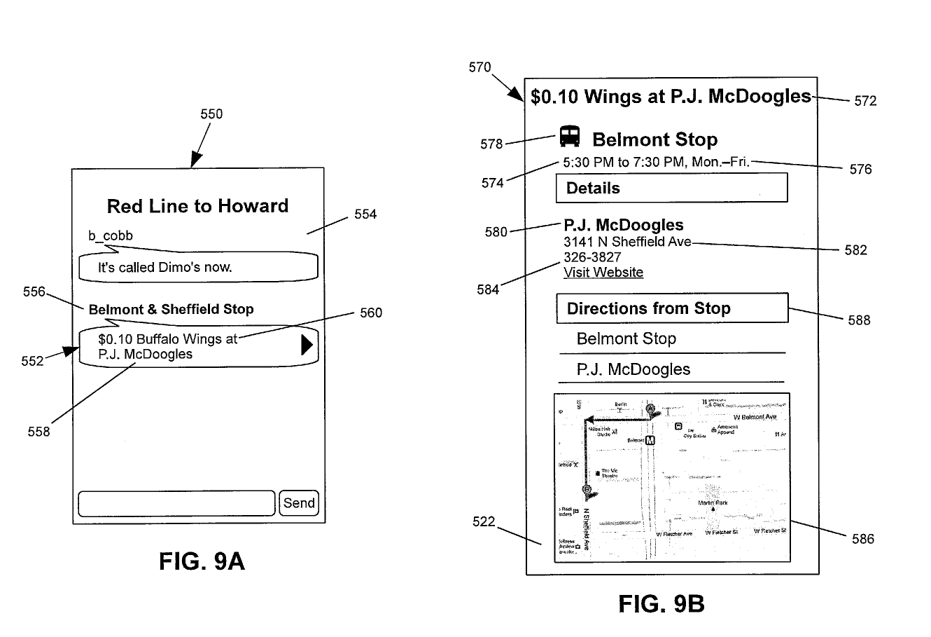

When the mobile application 108 receives a heartbeat response signal that includes an advertisement, the mobile application may present the advertisement data 188 associated with the advertisement to the commuter 102. Referring to FIG. 9A, an example of an implementation of an interface 550 that presents a predictive geotargeted advertisement 552 is shown. As seen in FIG. 9A, the mobile application 108, in this example, presents the advertisement 552 as a selectable message in the chat room 554 the commuter 102 is associated with. The advertisement 552, in this example, indicates the transit stop 556 the advertisement is associated with, the name 558 of the business, and the advertisement content 560.

The advertisement 552, in this example, is selectable, and the commuter 102 may select the advertisement 552 to display additional advertisement details. As shown above, an advertisement link may be associated with the advertisement 552. Accordingly, selecting the advertisement 552 in the chat room 554, in this example, may launch a web browser at the mobile device 110, which navigates to the advertisement link associated with the advertisement 552.

Accordingly, the web browser may submit a request to the mass transit commuter connection system 100 for the details associated with the advertisement 552. The request may be, for example, an HTTP request (HyperText Transfer Protocol). The HTTP request may include the unique advertisement identifier (e.g., ad_id) as shown above, which the mass transit commuter connection system 100 may use to retrieve the advertisement data 188 associated with the advertisement 552 from the data store 172. The mass transit commuter connection system 100 may then transmit the additional advertisement details back to the mobile application 108 at the mobile device 110 in, e.g., an HTTP response.

In FIG. 9B, an example of an implementation of an interface 570 for displaying additional advertisement details for the advertisement 552 is shown. As seen in FIG. 9B, the interface 570, in this example, includes: the content 572 of the advertisement 552; the time information 574 for the advertisement; the date information 576 for the advertisement; the name of the transit stop 578 associated with the advertisement; and the name 580 of the business, address 582 of the business, and contact information 584 of the business associated with the advertisement.

The interface 570, in this example, also includes a map 586 that displays directions 588 from the transit stop to the business. As shown above, the advertisement link may include the name of the stop and location information for the transit stop (e.g., latitude and longitude coordinates). The mass transit commuter connection system 100 may thus access a map service (e.g., Google Maps at maps.google.com) provided by a third-party system 194 to obtain directions from the transit stop associated with the advertisement 552 to the business address for the advertisement. The mass transit commuter connection system 100 may include the map 586 at the interface 570 displaying the additional details for the advertisement 552 as shown by way of example in FIG. 9B.

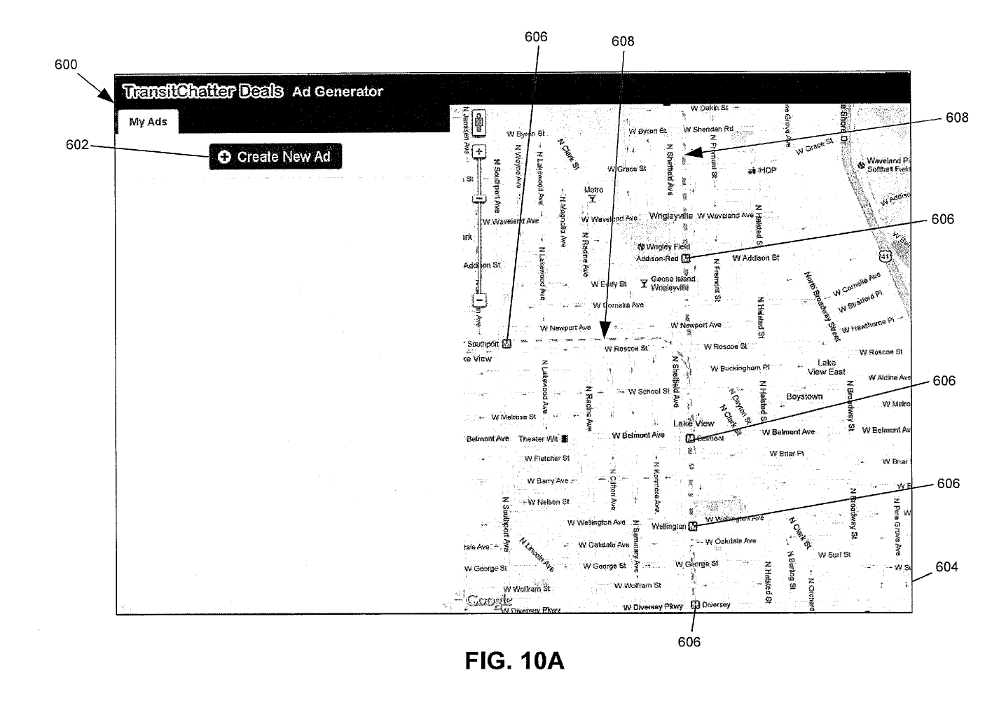

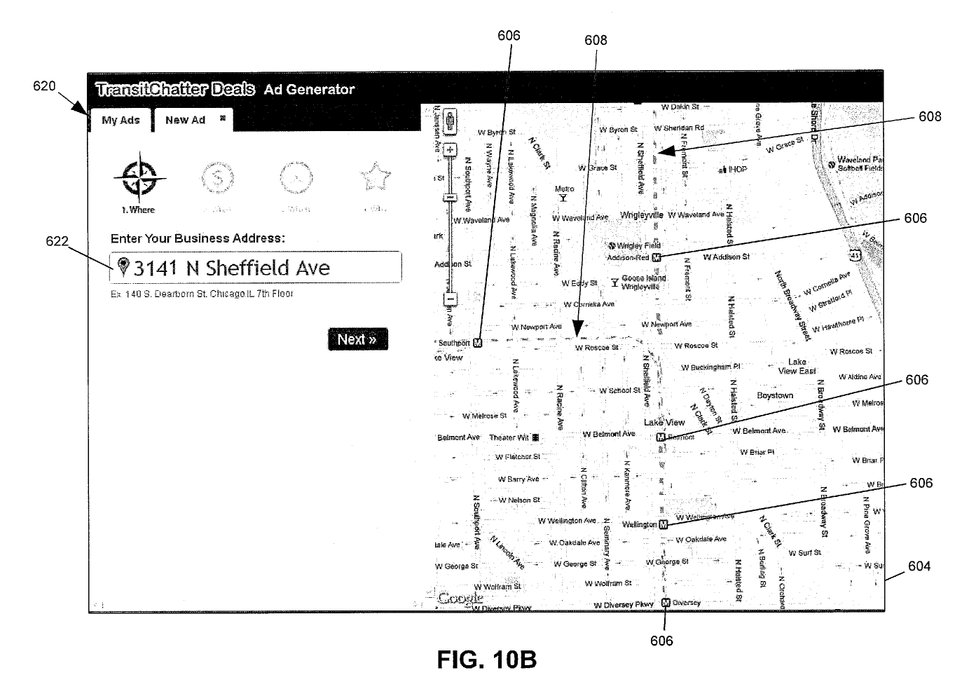

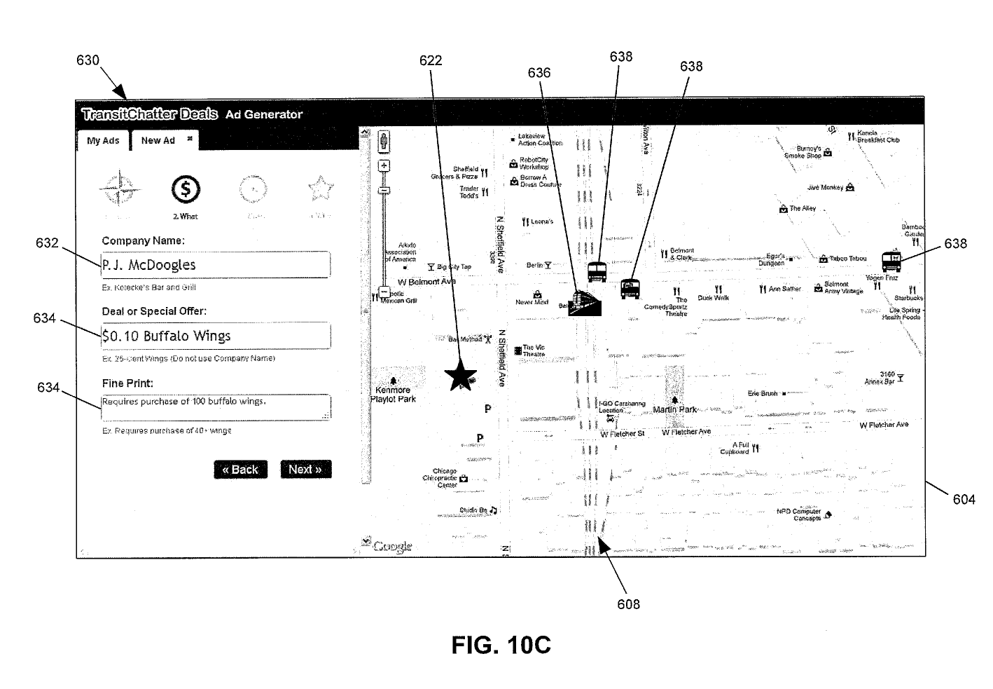

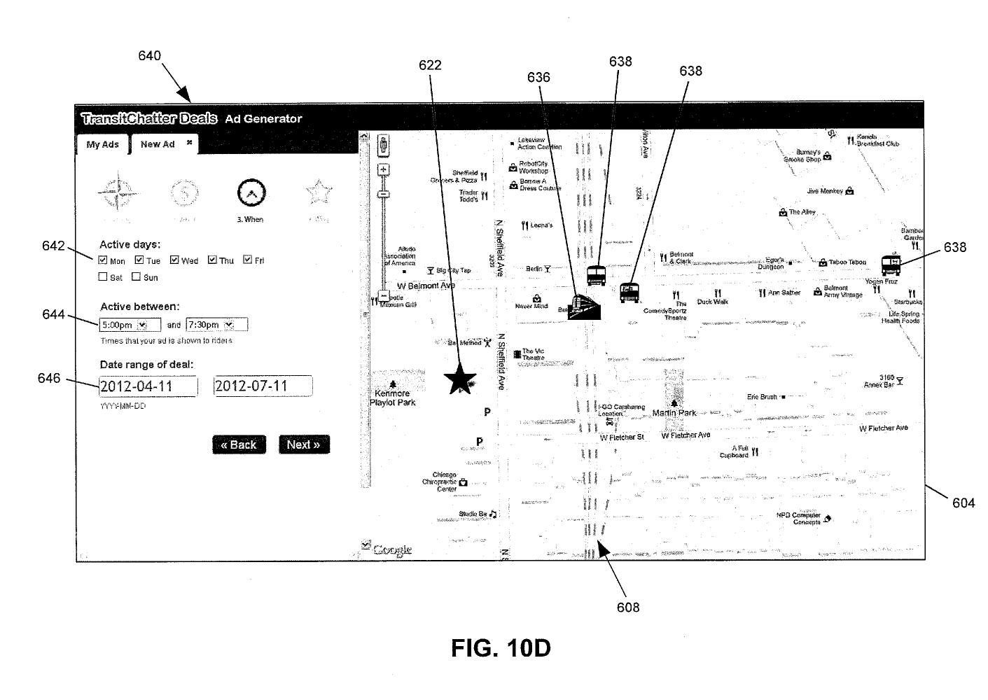

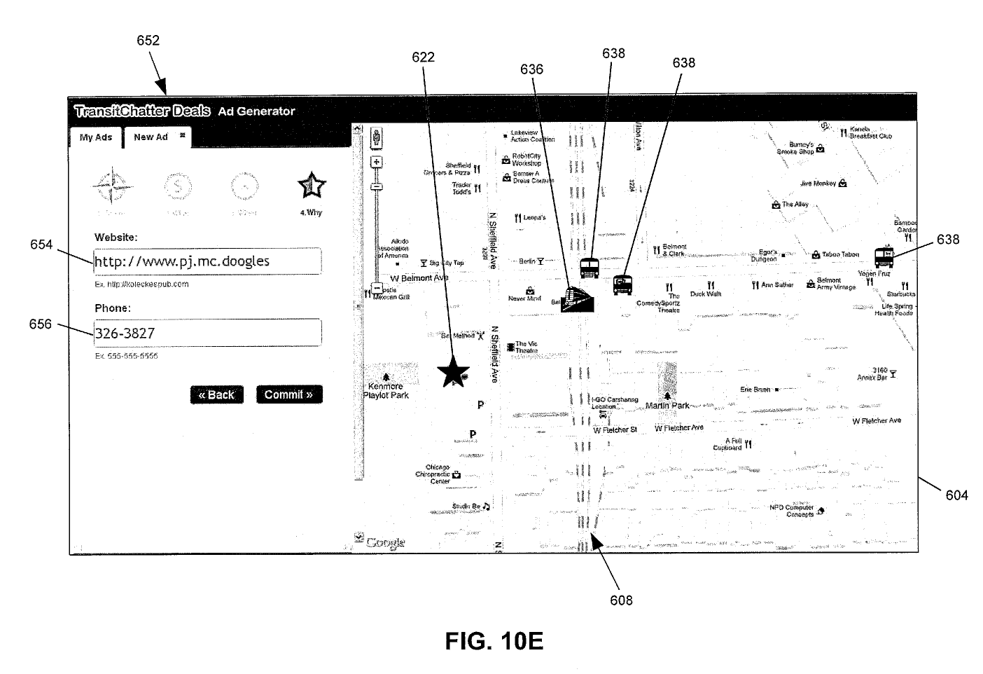

Referring now to FIGS. 10A-E, example interfaces of an action item management interface 168 is shown. The action items created and configured using the action item management interface 168 shown by way of example in FIGS. 10A-E are predictive geotargeted advertisements. It will be understood, however, that the action item management interface 168 may be utilized to create and configure other types of action items as mentioned above. The interfaces of the action item management interface 168, in this example, may be configured to receive advertisement data 188 from a user 190 in order to create and configure an advertisement. The interfaces may be, for example, HTML pages. A web server 166 at the mass transit commuter connection system 100 may host the action item management interface 168 and serve the action item management interface via a network 106 (e.g., the Internet) to a computing device 192 operated by a user 190. Accordingly, a user 190 may use a web browser at the computing device 192 to access the action item management interface 168 in order to create and configure predictive geotargeted advertisements.

In FIG. 10A, an example of an implementation of an interface 600 for creating a predictive geotargeted advertisement is shown. As seen in FIG. 10A, a user 190 may create a new advertisement by selecting the “Create New Ad” button 602 at the interface 600. The interface 600, in this example, includes a map 604 showing respective stops 606 along the routes of one or more transit lines 608 of a mass transit system. When a user 190 selects to create a new advertisement, the user may be prompted for information relating to the advertisement. As mentioned above, the data store 172 may store information related to the advertisement as advertisement data 188.

In FIG. 10B, an example of an implementation of an interface 620 for configuring a predictive geotargeted advertisement is shown. As seen in FIG. 10B, the interface 620 may prompt the user 190 for the address 622 of the business associated with the advertisement. In FIG. 10C, another example of an implementation of an interface 630 for configuring a predictive geotargeted advertisement is shown. As seen in FIG. 10C, the interface 630 may prompt the user 190 for the business name 632 and the content 634 of the advertisement.

When the user 190 provides the address 622 of the business, the map 604 may be updated to display the area surrounding the business address as shown by way of example in FIG. 10C. The interface 630 may also display one or more indicators 636 and 638 on the map 604 that highlight the stops along respective transit lines 608 within the vicinity of the business address 622. In FIG. 10C, for example, the map 604 displays an indicator 363 for one rail line stop and three indicators 638 for three respective bus line stops for the transit stops within the vicinity of the business address 622. In this way, users 190 may advantageously assess the type and quantity of mass transit stops are near their businesses.

When the advertisement is saved to the data store 172, the mass transit commuter connection system 100 may determine which transit stops are geographically located within the vicinity of the business address 622 and associate the advertisement with those transit stops as discussed above. As an example, the mass transit commuter connection system 100 may be configured to associate advertisements with transit stops located within a predetermined radius (e.g., two hundred feet) of the business address 622. In some example implementations, the action item management interface 168 may enable a user 190 to specify the radius (e.g., five hundred feet, seven hundred feet, etc.) such that transit stops located within the specified radius are associated with the advertisement and transit stops located outside the specified radius are not associated with the advertisement.

In FIG. 10D, an additional example of an interface 640 for configuring a predictive advertisement is shown. As seen in FIG. 10D, the interface 640 may also prompt the user 190 for timing information related to the advertisement. The interface 640 may enable the user 190 to specify, for example: the days 642 the advertisement is active; the time periods 644 during which the advertisement is active; and the date range 646 the advertisement is active. Accordingly, the predictive geotargeted advertising module 164 may filter or select advertisements based on the timing information 642, 644, and 646 when determining which advertisement to present to a commuter 102. If the current date, current day, or current time does not correspond to the timing information 642, 644, or 646 for an advertisement, then the predictive geotargeted advertising module 164 may exclude the advertisement from consideration when determining which advertisement to present to the commuter (e.g., by configuring the query to the data store 172, by filtering the advertisement result set, or by not selecting the advertisement for presentation).

As an example, a user 190 may configure a “happy hour” advertisement to run from Apr. 11, 2012 until Jul. 11, 2012. The user 190, in this example, may also configure the advertisement to be active Monday through Friday (weekdays) from 5:00 PM until 7:30 PM (happy hour). In this example, the predictive geotargeted advertising module 164 may exclude from consideration advertisements if: the current date is outside the specified date range 646; the current day is not a weekday, i.e., an active day 642; or the current time is outside the specified time period, i.e., an active time 644. In this way, users 190 may advantageously control when the mass transit commuter connection system 100 transmits advertisements to commuters 102 for presentation at the mobile applications 108 in order to target commuters on days and at times when the advertisements are most likely to be relevant (e.g., before or after work, before or after sporting events, weekend specials, etc.).

In FIG. 10E, a further example of an implementation of an interface 650 for configuring a predictive geotargeted advertisement is shown. As seen in FIG. 10E, the interface 650 may additionally prompt the user for contact information 652 relating to the advertisement. In this example, the contact information 652 associated with the advertisement includes a website 654 and a phone number 656. It will be understood that the action item management interface 168 may prompt a user 190 for additional or alternative information relating to an advertisement such as for example, demographic information that the predictive geotargeted advertising module 164 may utilize when filtering and selecting advertisements for presentation. It will also be understood that advertisements may also be related to, for example, events in addition to businesses. Accordingly, the action item management interface 168 may prompt a user 190 for event-related information associated with event-related advertisements (e.g., event name, promoter, etc.).

As demonstrated above, the mass transit commuter connection system 100 enables users 190 to target potential customers based not only on the current locations of those customers but also based on the predicted future locations of those customers. In this regard, the mass transit commuter connection system 100 offers a new type of advertising revenue model based around predictive geotargeted advertisements.

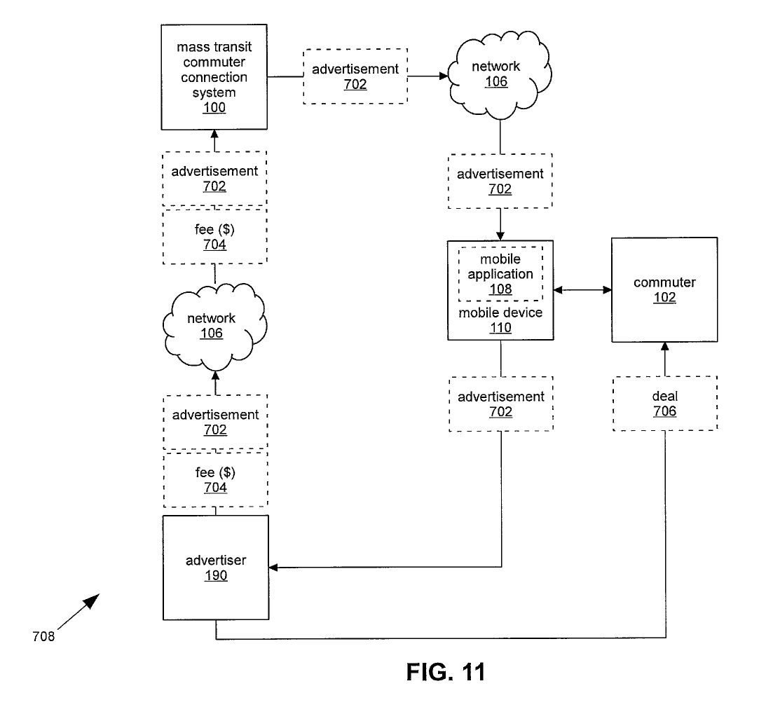

FIG. 11 is a diagram of an example of an advertising revenue model 700 based around predictive geotargeted advertisements 702. Users 190 may create predictive geotargeted advertisements 702, and the mass transit commuter connection system 100 may store the predictive geotargeted advertisements 702. As discussed above, the mass transit commuter connection system 100 may associate the predictive geotargeted advertisements 702 with transit stops of transit lines 112 of mass transit systems 104. The mass transit commuter connection system 100 may monitor the current location of commuters 102 traveling on the mass transit systems 104. As commuters 102 travel along the transit lines 112, the mass transit commuter connection system 100 may associate the commuters with the upcoming stops next for the commuters.

The mass transit commuter connection system 100 may identify advertisements 702 associated with the next upcoming stops for a commuter 102 and transmit those advertisements to a mobile application 108 at a mobile device 110 operated by the commuter. Presenting an advertisement 702 to a commuter 102 may be referred to as an impression. The user 190 may thus pay a fee 704 whenever an advertisement 702 is presented to a commuter 102 (e.g. $0.02 per impression) or in advance in bundles (e.g., 1000 impressions for $20.00). The user 190 may pay the fee 704 to the entity that provides and operates the mass transit commuter connection system 100. Fees 704 may be collected, in this example, via an electronic payment service (not shown). The user 190 may also pay a fee whenever a commuter 102 selects an advertisement 702 at the mobile device 110 for display of additional details corresponding to the advertisement. This type of revenue model may be referred to as a “click-through” revenue model. The mass transit commuter connection system 100 may track the number of “click-throughs” based on the requests (e.g., HTTP requests) received at the system from the mobile device 110 requesting the advertisement data (188 in FIG. 2) associated with a selected advertisement 702 as discussed above with reference to FIG. 9A and FIG. 9B.

Commuters 102 may view advertisements 702 received at the mobile application 108 on the mobile device 110. If the advertisement 702 is relevant to the commuter 102, then the commuter may visit the business associated with the advertisement. As mentioned above, the advertisement 702 may relate to a consumer deal 706. The commuter 102 may thus present the advertisement 702 at the business to receive the deal 706. In this way, users 190 may advantageously target potential customers that are known to be within the geographic vicinity of the business. Similarly commuters 102 may advantageously receive relevant and geographically convenient advertisements.

It will be understood and appreciated that one or more of the processes, sub-processes, and process steps described in connection with FIGS. 1-11 may be performed by hardware, software, or a combination of hardware and software on one or more electronic or digitally-controlled devices. The software may reside in a software memory (not shown) in a suitable electronic processing component or system such as, for example, one or more of the functional systems, devices, components, modules, or sub-modules schematically depicted in FIGS. 1-11. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module, which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., a mass transit commuter connection system 100, a mobile application 108, and add-on module 114 in FIG. 1), direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A system for presenting advertisements to a commuter traveling on a transit line of a mass transit system wherein the transit line includes multiple transit stops and the mass transit system is associated with transit description data, the system comprising:
a data store configured to store advertising-related data corresponding to the advertisements wherein the advertising-related data associates the advertisements with one or more transit stops of one or more transit lines of the mass transit system;
a predictive locator module that predicts one or more future geographic locations of the commuter based on a current geographic location of the commuter, the transit line on which the commuter is traveling, and a direction in which the commuter is traveling;
a predictive geotargeted advertising module that identifies and selects at least one of the advertisements for presentation to the commuter at a mobile device based on one or more of the future geographic locations of the commuter; and
a mobile communication gateway configured to transmit to the mobile device at least a portion of the advertising-related data corresponding to the advertisement such that at least a portion of the advertisement is presentable at the mobile device.

2. The system of claim 1 wherein:
the predictive locator module configured to
monitor the current geographic location of the commuter while the commuter travels on the transit line, and
associate the commuter with a current transit stop of the transit line based on the current geographic location of the commuter; and
wherein the predictive geotargeted advertising module is configured to
determine whether the current transit stop is associated with one or more of the advertisements, and
select one of the advertisements associated with the current transit stop for presentation at the mobile device operated by the commuter in response to a determination that the current transit stop is associated with one or more of the advertisements.

3. The system of claim 2 wherein the predictive locator module is further configured to:
identify a set of upcoming transit stops of the transit line on which the commuter is traveling based on the current geographic location of the commuter, a direction in which the commuter is traveling, and the transit description data; and
identify one of the upcoming transit stops in the set of upcoming transit stops as the current transit stop associated with the commuter.

4. The system of claim 3 wherein the transit description data includes geographic location information respectively associated with individual upcoming transit stops in the set of upcoming transit stops and wherein the predictive locator module is further configured to:
determine which transit stop in the set of upcoming transit stops the commuter will stop at next based on the current geographic location of the commuter and the geographic location information respectively associated with the individual upcoming transit stops in the set of upcoming transit stops; and
identify the upcoming transit stop in the set of upcoming transit stops that the commuter will stop at next as the current transit stop.

5. The system of claim 2 wherein the predictive geotargeted advertising module is further configured to:
identify a plurality of advertisements respectively associated with the current transit stop associated with the commuter; and
select the selected advertisement from the plurality of advertisements.

6. The system of claim 5 wherein the predictive geotargeted advertising module is configured to randomly select the selected advertisement from the plurality of advertisements.

7. The system of claim 5 wherein the predictive geotargeted advertising module is configured to select the selected advertisement from the plurality of advertisements based on one or more selection criteria.

8. The system of claim 7 wherein the selection criteria include at least one of:
preference information associated with the commuter;
profile information associated with the commuter;
historical information associated with the commuter; and
demographic information associated with the commuter.

9. The system of claim 5 wherein:
individual advertisements of the plurality of advertisements are associated with respective date ranges;
the individual advertisements are selectable by the predictive geotargeted advertising module on dates within the respective date ranges; and
the individual advertisements are not selectable by the predictive geotargeted advertising module on dates not within the respective date ranges.

10. The system of claim 5 wherein:
individual advertisements of the plurality of advertisements are associated with respective time periods;
the individual advertisements are selectable by the predictive geotargeted advertising module at times within the respective time periods; and
the individual advertisements are not selectable by the predictive geotargeted advertising module at times not within the respective time periods.

11. The system of claim 1 wherein directions are presented at the mobile device operated by the commuter when presenting at least a portion of the selected advertisement at the mobile device wherein the directions guide the commuter from the current transit stop associated with the selected advertisement to an address associated with the selected advertisement.

12. The system of claim 1 wherein one or more of the advertisements are associated with an advertiser and further comprising an advertisement creation interface configured to:
prompt the advertiser for the advertising-related data corresponding to the one or more advertisements associated with the advertiser; and
receive the advertising-related data from the advertiser as user input over a network.

13. The system of claim 12 wherein the advertising-related data includes an address associated with one of the advertisements associated with the advertiser and the predictive geotargeted advertising module is further configured to:
identify one or more transit stops of one or more transit lines of the mass transit system that are located within a predetermined radius around the address associated with the advertisement; and
associate the advertisement with the transit stops located within the predetermined radius around the address.

14. The system of claim 12 wherein the advertiser is charged a fee whenever one of the advertisements associated with the advertiser is selected for presentation at the mobile device operated by the commuter or whenever a request for additional details corresponding to one of the advertisements associated with the advertiser is received from the mobile device.

15. A computer-implemented method of predicting future locations of a commuter traveling on a transit line of a mass transit system wherein the transit line includes multiple transit stops and the mass transit system is associated with transit description data, the method comprising:
determining the transit line on which the commuter is traveling;
determining a direction in which the commuter is traveling;
determining automatically a current geographic location of the commuter based on geographic information received from a mobile device operated by the commuter;
identifying automatically a set of upcoming transit stops of the transit line on which the commuter is traveling based on the current geographic location of the commuter, the direction in which the commuter is traveling, and the transit description data; and
associating automatically the commuter with one or more of the upcoming transit stops in the set of upcoming transit stops.

16. The computer-implemented method of claim 15 further comprising:
identifying automatically one of the stops in the set of upcoming transit stops as a closest upcoming transit stop to the commuter based on the current geographic location of the commuter and geographic location information respectively associated with individual transit stops in the set of upcoming transit stops; and
associating automatically the commuter with the closest upcoming transit stop.

17. The computer-implemented method of claim 16 wherein identifying one of the stops in the set of upcoming transit stops as the closest upcoming transit stop includes:
comparing automatically the current geographic location of the commuter to the geographic location information respectively associated with individual upcoming transit stops in the set of transit stops;
calculating automatically respective distances between the commuter and the individual upcoming transit stops;
determining automatically which distance is a smallest distance; and
identifying automatically the upcoming transit stop in the set of upcoming transit stops that is associated with the smallest distance as the closest upcoming transit stop to the commuter.

18. The computer-implemented method of claim 16 further comprising:
determining automatically a new geographic location of the commuter in response to receipt of updated geographic information from the mobile device operated by the commuter;
identifying automatically one of the stops in the set of upcoming transit stops as a new closest upcoming transit stop to the commuter based on the new geographic location of the commuter and the geographic location information respectively associated with individual transit stops in the set of upcoming transit stops; and
associating automatically the commuter with the new closest upcoming transit stop.

19. The computer-implemented method of claim 16 further comprising:
determining that the commuter has traveled past the closest upcoming transit stop in response to receipt of updated geographic information from the mobile device operated by the commuter;
ordering the set of upcoming transit stops in sequential order based on respective sequence numbers associated with individual transit stops in the set of upcoming transit stops to obtain an ordered set of upcoming transit stops;
determining which transit stop in the ordered set of upcoming transit stops is located sequentially after the closest upcoming transit stop based on the sequence numbers;
identifying the transit stop located sequentially after the closest upcoming transit stop in the ordered set of transit stops as a new closest upcoming transit stop; and
associating the commuter with the new closest upcoming transit stop.

20. The computer-implemented method of claim 19 further comprising:
determining automatically which transit stops in the ordered set of upcoming transit stops are located sequentially after the new closest upcoming transit stop;
identifying automatically the transit stops located sequentially after the new closest upcoming transit stop in the ordered set of transit stops as respective subsequent upcoming transit stops; and
associating automatically the commuter with one or more of the subsequent upcoming transit stops.

21. The computer-implemented method of claim 15 wherein:
determining the transit line the commuter is traveling on includes automatically prompting the commuter at the mobile device to manually identify the transit line the commuter is traveling on; and
determining the direction in which the commuter is traveling includes automatically prompting the commuter at the mobile device to manually identify the direction in which the commuter is traveling.

22. The computer-implemented method of claim 15 wherein:
determining the transit line the commuter is traveling on includes automatically determining the transit line the commuter is traveling on based on the geographic information received from the mobile device operated by the commuter; and
determining the direction in which the commuter is traveling includes automatically determining the direction in which the commuter is traveling based on the geographic information received from the mobile device.

23. The computer-implemented method of claim 22 further comprising prompting the commuter at the mobile device to confirm the transit line the commuter is traveling on and the direction in which the commuter is traveling.

24. The computer-implemented method of claim 15 further comprising:
determining automatically whether one of the upcoming transit stops in the set of upcoming transit stops is associated with one or more action items; and
executing automatically one of the action items associated with the upcoming transit stop in response to a determination that the upcoming stop is associated with one or more action items.

25. The computer-implemented method of claim 24 wherein the action item is presenting an advertisement associated with the upcoming transit stop at the mobile device operated by the commuter.

26. A system for connecting a set of commuters traveling on respective transit lines of one or more mass transit systems comprising:
a session management module configured to establish a set of connections with a respective set of mobile devices wherein individual mobile devices in the set of mobile devices are respectively operated by individual commuters in the set of commuters and associate individual commuters in the set of commuters with the respective transit lines on which the individual commuters are traveling; and
a mobile communication gateway configured to receive one or more communications from one or more mobile devices in the set of mobile devices and transmit at least a portion of one or more of the communications received to individual mobile devices in the set of mobile devices for presentation to the commuters that respectively operate the individual mobile devices.

27. The system of claim 26 wherein the session management module is further configured to automatically associate a first commuter in the set of commuters and a second commuter in the set of commuters with each other based on a predetermined criterion wherein:
the session management module associates the first commuter and the second commuter with each other in response to a determination that the predetermined criterion is satisfied; and
the session management module does not associate the first commuter and the second commuter with each other in response to a determination that the predetermined criterion is not satisfied.

28. The system of claim 27 wherein the predetermined criterion includes whether the first commuter and the second commuter are traveling on a same transit line and further comprising a predictive locator module configured to:
identify the respective transit lines on which the first commuter and the second commuter are traveling;
determine whether the first commuter and the second commuter are traveling on the same transit line;
wherein the session management module associates the first commuter and the second commuter with each other in response to a determination that the first commuter and the second commuter are traveling on the same transit line; and
wherein the session management module does not associate the first commuter and the second commuter with each other in response to a determination that the first commuter and the second commuter are not traveling on the same transit line.

29. The system of claim 28 wherein the predetermined criterion further includes whether the first commuter and the second commuter are traveling in a same direction and the predictive locator module is further configured to:
identify respective directions in which the first commuter and the second commuter are traveling;
determine whether the first commuter and the second commuter are traveling in the same direction;
wherein the session management module associates the first commuter and the second commuter with each other in response to a determination that the first commuter and the second commuter are traveling on the same transit line and in the same direction; and
wherein the session management module does not associate the first commuter and the second commuter with each other in response to a determination that the first commuter and the second commuter are not traveling on the same transit line or are not traveling in the same direction.

30. The system of claim 28 wherein the session management module associates the first commuter and the second commuter with each other by associating the first commuter and the second commuter with the same transit line on which the first commuter and the second commuter are traveling.

31. The system of claim 26 wherein individual communications of the one or more communications received are chat messages, wherein individual commuters in the set of commuters are traveling on a common transit line, and further comprising a chat management module configured to:
maintain a chat room corresponding to the common transit line;
associate the individual commuters traveling on the common transit line with the chat room; and
associate chat messages received from the individual commuters with the chat room such that the chat messages associated with the chat room are presentable to the individual commuters associated with the chat room at the mobile devices respectively operated by the individual commuters.

32. The system of claim 26 wherein the session management module is further configured to:
create a session associated with one of the mobile devices in the set of mobile devices in order to establish the connection with the mobile device operated by one of the commuters;
maintain the session associated with the mobile device in response to receipt of a periodic signal received from the mobile device; and
removing the session associated with the mobile device in response to a determination that the periodic signal has not been received for a predetermined time period.

33. The system of claim 26 wherein the periodic signal includes geographic information that identifies a current geographic location of the commuter operating the mobile device the periodic signal is received from and includes heading information that identifies a direction in which the commuter is traveling and further comprising a predictive locator module configured to:
determine the transit line on which the commuter is traveling based on the geographic information included in the periodic signal; and
determine the direction in which the commuter is traveling based on the heading information included in the periodic signal.

34. The system of claim 33 wherein the session management module is further configured to:
determine whether the commuter has exited the transit line the commuter is associated with based on a comparison of the current geographic location of the commuter to respective geographic locations of one or more transit stops of the transit line the commuter is associated with; and
remove the session associated with the commuter in response to a determination that the commuter has exited the transit line the commuter is associated with.

35. The system of claim 26 further comprising:
a real-time transit data collection module configured to collect real-time transit data corresponding to one of the transit lines of one of the mass transit systems wherein the real-time transit data describes a current status of the transit line; and
wherein the mobile communication gateway is further configured to transmit the real-time transit data to individual mobile devices in the set of mobile devices that are respectively operated by individual commuters in the set of commuters that are traveling on the transit line corresponding to the real-time transit data for presentation to the individual commuters.
